(19) United States
(12) Patent Application Publication
(10) Pub. No.: US 2017/0343869 A1
(43) Pub. Date: Nov. 30, 2017

(54) LIQUID CRYSTAL DISPLAY DEVICE

(71) Applicant: Sharp Kabushiki Kaisha, Sakai City, Osaka (JP)

(72) Inventors: SATOSHI MATSUMURA, Sakai City (JP); MITSUHIRO MURATA, Sakai City (JP); YOSUKE IWATA, Sakai City (JP)

(21) Appl. No.: 15/532,734

(22) PCT Filed: Nov. 27, 2015
(86) PCT No.: PCT/JP2015/083320

§ 371 Date: Jun. 2, 2017

(30) Foreign Application Priority Data
Dec. 4, 2014 (JP) 2014-246148

(51) Int. Cl. G02F 1/1343; G02F 1/133; G02F 1/137; G02F 1/1337; G02F 1/1368

(52) U.S. Cl. CPC G02F 1/134363; G02F 1/133707; G02F 1/1368; G02F 1/137; G02F 1/13306; G02F 2001/133738; G02F 2001/13706; G02F 2201/124; G02F 2201/128; G02F 2202/10; G02F 2001/134372

(57) ABSTRACT

The present invention provides a liquid crystal display device that may realize a wide viewing angle and realize a high-speed response. The liquid crystal display device of the present invention is a liquid crystal display device that has upper and lower substrates and a liquid crystal layer which is interposed between the upper and lower substrates, in which the lower substrate includes electrodes, the electrodes are configured with a first electrode, a second electrode in a different layer from the first electrode, and a third electrode in a same layer as the second electrode, the liquid crystal layer includes liquid crystal molecules that are horizontally aligned with respect to a main surface of the upper and lower substrates in a case where a voltage is not applied, and the liquid crystal display device is configured to execute a driving operation that causes the electrodes to generate an electric field which causes a portion of the liquid crystal molecules to rotate in a horizontal plane with respect to the main surface and causes another portion of the liquid crystal molecules to rotate in an opposite direction to the portion of the liquid crystal molecules in the horizontal plane with respect to the main surface.

### TECHNICAL FIELD

The present invention relates to a liquid crystal display device, more particularly to a liquid crystal display device that performs display by applying an electric field by plural electrodes.

### BACKGROUND ART

Liquid crystal display devices are configured by interposing liquid crystal display elements between a pair of glass substrates or the like and have become necessary items for daily life and business such as a car navigation system, an electronic book, a photo frame, industrial equipment, a television, a personal computer, a smartphone, and a tablet terminal by utilizing advantages such as a thin form, a light weight, and low power consumption. In those uses, various modes of liquid crystal display devices that are related to electrode arrangement and substrate designs for changing optical characteristics of liquid crystal layers have been discussed.

Examples of display schemes of liquid crystal display devices in recent years include a vertical alignment (VA) mode such as a multi-domain vertical alignment (MVA) mode in which liquid crystal molecules with negative dielectric anisotropy are vertically aligned with respect to a substrate surface, an in-plane switching (IPS) mode in which liquid crystal molecules with positive or negative dielectric anisotropy are horizontally aligned with respect to the substrate surface and a lateral electric field is applied to a liquid crystal layer, a fringe field switching (FFS) mode, and so forth.

Among those, the FFS mode is a liquid crystal mode that is widely used for smartphones and tablet terminals in recent years. As a liquid crystal display device of the FFS mode, for example, the following liquid crystal display device of the FFS mode is disclosed. The liquid crystal display device of the FFS mode includes: first and second transparent insulating substrates which are oppositely arranged at a prescribed distance via a liquid crystal layer including plural liquid crystal molecules; plural gate bus lines and data bus lines which are formed on the first transparent substrate and arranged in a matrix manner so as to limit unit pixels; a thin-film transistor which is provided in an intersection portion between the gate bus line and the data bus line; a counter electrode which is arranged in each of the unit pixels and is formed of a transparent conductor; and a pixel electrode which is arranged in each of the unit pixels, while being insulated from the counter electrode, so as to form a fringe field together with the counter electrode, has plural upper slits and lower slits which are disposed at a prescribed inclination so as to form symmetry with respect to a long side of the pixel as a center, and is formed of the transparent conductor (for example, see PTL 1).

### CITATION LIST

### Patent Literature

PTL 1: Japanese Unexamined Patent Application Publication No. 2002-182230

### SUMMARY OF INVENTION

### Technical Problem

PTL 1 discloses that a liquid crystal display device of an FFS mode disclosed in PTL 1 has wide viewing angle characteristics and improves low aperture ratio and transmittance of a liquid crystal display device of an IPS mode (for example, see FIG. 6 disclosed in PTL 1. FIG. 6 disclosed in PTL 1 illustrates a planar pixel structure of the liquid crystal display device of the FFS mode). However, the liquid crystal display device of the FFS mode disclosed in PTL 1 causes liquid crystals to forcibly respond by electric field application in a rise but causes the liquid crystals to respond by viscoelasticity in a fall while stopping the electric field application. Thus, the response is slow compared to a vertical alignment mode, and there is a room for improvement in response characteristics.

One example of the liquid crystal display device of the FFS mode disclosed in PTL 1 will be described with reference to FIG. 38. FIG. 38 is a cross-sectional schematic diagram of a liquid crystal display device that has an electrode structure of the FFS mode in related art. FIG. 38 illustrates a structure of the liquid crystal display device and, on a lower substrate 1110 on which an upper layer electrode (iv) as an electrode provided with slits is arranged, the upper layer electrode (iv) and a lower layer electrode (v) as a plane electrode are arranged while interposing an insulating layer 1113 between the upper layer electrode (iv) and the lower layer electrode (v). In the liquid crystal display device, a regular voltage is applied to the upper layer electrode (iv) in the rise (for example, it is sufficient that the electric potential difference between the upper layer electrode (iv) and the lower layer electrode (v) is equal to or higher than a threshold value and a response may be obtained by a fringe electric field. The threshold value means a voltage value at which a liquid crystal layer causes an optical change and an electric field occurs in which the display state changes in the liquid crystal display device). In the fall, the electric potential difference between the upper layer electrode (iv) and the lower layer electrode (v) is set as lower than the threshold value, and the response is obtained by stopping (lowering) the fringe electric field.

In the FFS mode in related art, as described above, the fringe electric field is generated by an FFS electrode of the lower substrate, liquid crystal molecules around a lower electrode are caused to rotate in the same direction in a horizontal plane, and switching in the rise is thereby performed. Further, the switching in the fall is performed by returning the liquid crystal molecules to an original alignment state due to the viscoelasticity by turning off the fringe electric field.

However, a region in which the electric field for causing the liquid crystal molecules to rotate is weak is present in the liquid crystal layer, and a time is requested for rotation of the liquid crystal molecules in the region. Further, in this case, because the liquid crystal molecules rotate in the same direction, strain of the liquid crystals in the horizontal plane due to elastic deformation is low. Thus, in a case where the switching in the fall is performed by turning off the electric field, the response is slow because a restoring force due to elastic strain that works for returning to the original alignment state is small. Accordingly, the response time is slow for both of the switching in the rise and the switching in the fall.

The present invention has been made in consideration of an above present circumstance, and an object thereof is to provide a liquid crystal display device that may realize a wide viewing angle and realize a high-speed response.

### Solution to Problem

The present inventors have discussed about various liquid crystal display devices that perform display by applying an electric field by plural electrodes and focused on electrode structures of a lower substrate. Then, a liquid crystal display device of an FFS mode in related art is configured with two layers in the lower substrate and electrodes that may apply two kinds of voltages. However, the present inventors have conceived a configuration with two layers in the lower substrate and electrodes that may apply three kinds of voltages and has reached the present invention. Here, initial alignment of liquid crystal molecules is set as horizontal alignment with respect to a main surface of upper and lower substrates.

Further, the present inventors have found a driving scheme (first driving scheme) in which a voltage of a first electrode (for example, an upper layer electrode) is changed, a regular alternating-current voltage is applied to a second electrode (for example, a lower layer electrode), a third electrode (for example, a lower layer electrode) is continuously set to 0 V, and liquid crystals are thereby driven. Further, the present inventors have conceived driving the liquid crystals while the second electrode and the third electrode are switched to the same electric potential (second driving scheme) and have found switching between the first driving scheme and the second driving scheme.

That is, a liquid crystal display device of the present invention is different from the invention disclosed in PTL 1 in a point that the liquid crystal display device of the present invention is configured such that the lower substrate has at least two layers and has electrodes that may apply three kinds of voltages.

That is, one aspect of the present invention may be a liquid crystal display device that has upper and lower substrates and a liquid crystal layer which is interposed between the upper and lower substrates, in which the lower substrate includes electrodes, the electrodes are configured with a first electrode, a second electrode in a different layer from the first electrode, and a third electrode in a same layer as the second electrode, the liquid crystal layer includes liquid crystal molecules that are horizontally aligned with respect to a main surface of the upper and lower substrates in a case where a voltage is not applied, and the liquid crystal display device is configured to execute a driving operation that causes the electrodes to generate an electric field which causes a portion of the liquid crystal molecules to rotate in a horizontal plane with respect to the main surface and causes another portion of the liquid crystal molecules to rotate in an opposite direction to the portion of the liquid crystal molecules in the horizontal plane with respect to the main surface.

Generation of the electric field by the electrodes may be generation of the electric field by at least one electrode that is selected from the first electrode, the second electrode, and the third electrode. For example, in a case where a power source of the liquid crystal display device is turned on, the electric field is preferably continuously generated between the second electrode and the third electrode, the liquid crystal molecules are preferably caused to rotate by raising the voltage of the first electrode in a case of white display, and the liquid crystal molecules are preferably caused to rotate in an opposite direction by decreasing the voltage of the first electrode in a case of black display.

For example, in the liquid crystal display device of the present invention that is driven with a lateral electric field, two layers of electrodes in which a lower layer is provided with comb-shaped electrodes and an upper layer is provided with a slit electrode (or a comb-shaped electrode) are arranged via an insulating film. The liquid crystal display device is preferably driven such that the lateral electric field is continuously applied between the combshaped electrodes on the lower layer side (an opposite side to a liquid crystal layer side) of the two layers of electrodes and a voltage is applied to the slit electrode (or the comb-shaped electrode) on the upper layer side.

In one preferable form in the present invention, the lower substrate is configured with two layers of electrodes, the lower layer electrodes are a pair of the comb-shaped electrodes, and the upper layer electrode is the slit electrode in a liquid crystal mode with horizontal type initial alignment.

A portion of the liquid crystal molecules means a portion of the liquid crystal molecules among the liquid crystal molecules included in the liquid crystal layer. Another portion of the liquid crystal molecules is similar and means another portion of the liquid crystal molecules among the liquid crystal molecules included in the liquid crystal layer, other than the portion of the liquid crystal molecules.

In the liquid crystal display device of the present invention, the first electrode, the second electrode, and the third electrode are usually electrically separated from each other, and voltages of those may be controlled individually. In other words, each of the first electrode, the second electrode, and the third electrode may usually be set to a different electric potential at a threshold value voltage or higher. The liquid crystal display device of the present invention is preferably configured such that the second electrode and the third electrode of the lower substrate configure the pair of comb-shaped electrodes and the slit electrode or the comb-shaped electrode as the first electrode is arranged on the second electrode and the third electrode via an insulating layer or the like, for example.

That is, the first electrode is preferably arranged closer to the liquid crystal layer side than the second electrode and the third electrode. Further, each of the second electrode and the third electrode is preferably in a comb shape. In addition, in a plan view of the main surface of the upper and lower substrates, an extending direction of the second electrode and an extending direction of the third electrode preferably intersect with an alignment direction of the liquid crystal molecules in a case where a voltage is not applied. Further, a comb interval of the second electrode and the third electrode is preferably 3 μm or more and 6 μm or less. Further, the first electrode is preferably provided with slits or is preferably in a comb shape. In addition, in a plan view of the main surface of the upper and lower substrates, an angle that is formed between an extending direction of the first electrode and the alignment direction of the liquid crystal molecules in a case where a voltage is not applied is preferably −7° or larger and 7° or smaller. Note that as for the angle that is formed between the extending direction of the first electrode and the alignment direction of the liquid crystal molecules in a case where a voltage is not applied, a rightward rotation angle that is formed by the alignment direction of the liquid crystal molecules with respect to the extending direction of an upper layer electrode (i) is assumed as a positive angle, and a leftward rotation angle that is formed with respect to the extending direction of the upper layer electrode (i) is assumed as a negative angle.

Further, in a plan view of the main surface of the upper and lower substrates, an angle that is formed between the extending direction of the first electrode and the extending direction of the second electrode and the extending direction of the third electrode is preferably 83° to 90°. That is, each of the angle formed between the extending direction of the first electrode and the extending direction of the second electrode and the angle formed between the extending direction of the first electrode and the extending direction of the third electrode is preferably 83° to 90°. Note that it is preferable that the extending direction of the second electrode is substantially parallel to the extending direction of the third electrode.

Note that the extending direction of the slit electrode (slit extending direction) represents the longitudinal direction of linear electrodes that configure the slit electrode. The extending direction of the comb-shaped electrode represents the longitudinal direction of linear electrodes as branch portions among a stem portion and the branch portions that extend from the stem portion, which configure the comb-shaped electrode. In the liquid crystal display device of the FFS mode in related art, a fringe electric field is generated by an FFS electrode of the lower substrate in the rise, and the fringe electric field causes the liquid crystal molecules to rotate only in one direction. However, in the liquid crystal display device of the present invention, the lower substrate is configured with the two layers and with the electrodes (the above-described first electrode, second electrode, and third electrode) that may apply three kinds of voltages. For example, the electric field is generated between the first electrode and the second electrode in the rise, and the liquid crystal molecules in one region and the liquid crystal molecules in the other region are caused to rotate in the opposite directions to each other in the horizontal plane. Further, an electric field is generated between the second electrode and the third electrode in a fall, the liquid crystal molecules in the one region and the liquid crystal molecules in the other region are caused to rotate in the respective opposite directions to the rise in the horizontal plane.

The liquid crystal display device of the present invention is preferably configured to execute a driving operation that causes the electrodes to generate an electric field which causes the liquid crystal molecules to rotate such that two or more first regions, the first region in which a portion of the liquid crystal molecules is aligned in one direction, and two or more second regions, the second region in which another portion of the liquid crystal molecules is aligned in a different direction from the portion of the liquid crystal molecules, are alternately arranged in a picture in a plan view of the main surface of the upper and lower substrates.

A case where two or more first regions and two or more second regions are alternately arranged may be a case where two or more first regions and two or more second regions are alternately arranged in a stripe manner or may be alternately arranged in a houndstooth check manner.

Slits are preferably provided in at least one of the first electrode, the second electrode, and the third electrode, and the liquid crystal display device is preferably configured to execute a driving operation that causes the electrodes to generate an electric field which causes a portion of the liquid crystal molecules to rotate in the horizontal plane with respect to the main surface and causes another portion of the liquid crystal molecules to rotate in an opposite direction to the portion of the liquid crystal molecules in the horizontal plane with respect to the main surface in a region which overlaps with the slits in a plan view of the main surface of the upper and lower substrates.

Note that herein, in a case of describing “a portion of the liquid crystal molecules is caused to rotate in the horizontal plane with respect to the main surface and another portion of the liquid crystal molecules is caused to rotate in an opposite direction to the portion of the liquid crystal molecules in the horizontal plane with respect to the main surface in a region which overlaps with the slits”, a portion of the liquid crystal molecules may be caused to rotate in the horizontal plane, and another portion of the liquid crystal molecules may be caused to rotate in an opposite direction to the portion of the liquid crystal molecules in the horizontal plane in at least one region that overlaps with one slit and corresponds to one slit in a plan view of the main surface of the upper and lower layer. However, a portion of the liquid crystal molecules is preferably caused to rotate in the horizontal plane, and another portion of the liquid crystal molecules is preferably caused to rotate in an opposite direction to the portion of the liquid crystal molecules in the horizontal plane in each of the regions that overlaps with one slit and corresponds to one slit.

Moreover, the first electrode is preferably provided with slits, and the second electrode and the third electrode preferably configure a pair of comb-shaped electrodes. The liquid crystal display device is preferably configured to execute a driving operation that causes the electrodes to generate an electric field which causes a portion of the liquid crystal molecules to rotate in the horizontal plane with respect to the main surface and another portion of the liquid crystal molecules to rotate in an opposite direction to the portion of the liquid crystal molecules in the horizontal plane with respect to the main surface in a region which overlaps with the slit provided to the first electrode in a plan view of the main surface of the upper and lower substrates and causes a portion of the liquid crystal molecules to rotate in the horizontal plane with respect to the main surface and another portion of the liquid crystal molecules to rotate in an opposite direction to the portion of the liquid crystal molecules in the horizontal plane with respect to the main surface in a region which overlaps with a region between combs of the second electrode and the third electrode.

In the liquid crystal display device of the present invention, an electrode for driving the liquid crystals may be arranged on the upper substrate or may not be arranged. However, the electrode is preferably not arranged. That is, the electrode for driving the liquid crystals is preferably arranged only on the lower substrate.

In addition, the shape of the first electrode is not particularly limited. However, for example, the first electrode that is provided with the slits is one preferable form of the present invention. The first electrode that is in a comb shape is also one preferable form of the present invention. Herein, an electrode whose shape is a comb shape will not be referred to as an electrode that is provided with slits but as a comb-shaped electrode.

Further, the liquid crystal display device of the present invention is preferably configured to execute the first driving scheme that executes the driving operation and to execute the second driving scheme that executes a driving operation which causes the electrodes to generate an electric field which causes the liquid crystal molecules to rotate in one direction in the horizontal plane with respect to the main surface of the upper and lower substrates while the first driving scheme and the second driving scheme are switched. Rotating in one direction may be rotating substantially in one direction. Further, generation of the electric field by the electrodes may be generation of the electric field by at least one electrode that is selected from the first electrode, the second electrode, and the third electrode. For example, it is preferable that a voltage is applied to the first electrode in the case of white display to generate an electric field, the liquid crystal molecule are thereby caused to rotate, the voltage applied to the first electrode is decreased in the case of black display to lower (turn off) the electric field, and the liquid crystal molecules are thereby caused to rotate in the opposite direction.

The configuration of the liquid crystal display device of the present invention is not particularly limited by other configuration elements but may appropriately employ other configurations that are usually used for liquid crystal display devices.

### ADVANTAGEOUS EFFECTS OF INVENTION

The liquid crystal display device of the present invention may realize a wide viewing angle and realize a high-speed response.

### BRIEF DESCRIPTION OF DRAWINGS

FIG. 1 is a plan schematic diagram that illustrates electrode structures and initial alignment of liquid crystal molecules of a pixel of a liquid crystal display device of a first embodiment.

FIG. 2 is a cross-sectional schematic diagram that illustrates a cross section which corresponds to a line segment indicated by the one-dot chain line in FIG. 1.

FIG. 3 is a plan schematic diagram that illustrates an applied voltage to each electrode and alignment of the liquid crystal molecules in a case of white display by a first driving scheme of the first embodiment.

FIG. 4 is a simulation result that illustrates a director distribution and a transmittance distribution which correspond to FIG. 3.

FIG. 5 is a plan schematic diagram that illustrates the applied voltage to each of the electrodes and the alignment of the liquid crystal molecules in a case of black display by the first driving scheme of the first embodiment.

FIG. 6 is a voltage relationship diagram that illustrates the applied voltage to each of the electrodes in the case of white display by the first driving scheme of the first embodiment.

FIG. 7 is a plan schematic diagram that illustrates the applied voltage to each of the electrodes and the alignment of the liquid crystal molecules in the case of white display by a second driving scheme of the first embodiment.

FIG. 8 is a simulation result that illustrates the director distribution and the transmittance distribution which correspond to FIG. 7.

FIG. 9 is a plan schematic diagram that illustrates the applied voltage to each of the electrodes and the alignment of the liquid crystal molecules in the case of black display by the second driving scheme of the first embodiment.

FIG. 10 is a plan schematic diagram that illustrates one example of a pixel layout in a case where the liquid crystal display device of the first embodiment is driven with TFTs.

FIG. 11 is a graph that represents respective voltage-transmittance (V-T) characteristics of an upper layer electrode (i) of the first driving scheme and the second driving scheme of the first embodiment.

FIG. 12 is a graph that represents standardized transmittances with respect to time in rises of the first embodiment and a first comparative example.

FIG. 13 is a graph that represents the standardized transmittances with respect to time in falls of the first embodiment and the first comparative example.

FIG. 14 is a plan schematic diagram that illustrates the applied voltage to each of the electrodes and the alignment of the liquid crystal molecules in the case of white display by the first driving scheme of a second embodiment.

FIG. 15 is a simulation result that illustrates the director distribution and the transmittance distribution which correspond to FIG. 14.

FIG. 16 is a plan schematic diagram that illustrates the applied voltage to each of the electrodes and the alignment of the liquid crystal molecules in the case of black display by the first driving scheme of the second embodiment.

FIG. 17 is a voltage relationship diagram that illustrates the applied voltage to each of the electrodes in the case of white display by the first driving scheme of each of the first embodiment and the second embodiment.

FIG. 18 is a plan schematic diagram that illustrates one example of the pixel layout in a case where the liquid crystal display device of the second embodiment is driven with the TFTs.

FIG. 19 is a graph that represents the respective voltage-transmittance (V-T) characteristics of the upper layer electrodes (i) in the first driving scheme of the first embodiment and the second embodiment.

FIG. 20 is a plan schematic diagram that illustrates the electrode structures and the initial alignment of the liquid crystal molecules of the pixel of the liquid crystal display device of a third embodiment.

FIG. 21 is a cross-sectional schematic diagram that illustrates a cross section which corresponds to a line segment indicated by the one-dot chain line in FIG. 20.

FIG. 22 is a plan schematic diagram that illustrates the electrode structures and the initial alignment of the liquid crystal molecules of the pixel of the liquid crystal display device of a fourth embodiment.

FIG. 23 is a cross-sectional schematic diagram that illustrates a cross section which corresponds to a line segment indicated by the one-dot chain line in FIG. 22.

FIG. 24 is a plan schematic diagram that illustrates the electrode structures and the initial alignment of the liquid crystal molecules of the pixel of a liquid crystal display device of a fifth embodiment.

FIG. 25 is a cross-sectional schematic diagram that illustrates a cross section which corresponds to a line segment indicated by the one-dot chain line in FIG. 24.

FIG. 26 is a plan schematic diagram that illustrates the electrode structures and the initial alignment of the liquid crystal molecules of the pixel of the liquid crystal display device of a sixth embodiment.

FIG. 27 is a cross-sectional schematic diagram that illustrates a cross section which corresponds to a line segment indicated by the one-dot chain line in FIG. 26.

FIG. 28 is a plan schematic diagram that illustrates the electrode structures and the initial alignment of the liquid crystal molecules of the pixel of the liquid crystal display device of a seventh embodiment.

FIG. 29 is a cross-sectional schematic diagram that illustrates a cross section which corresponds to a line segment indicated by the one-dot chain line in FIG. 28.

FIG. 30 is a plan schematic diagram that illustrates the electrode structures and the initial alignment of the liquid crystal molecules of the pixel of the liquid crystal display device of an eighth embodiment.

FIG. 31 is a cross-sectional schematic diagram that illustrates a cross section which corresponds to a line segment indicated by the one-dot chain line in FIG. 30.

FIG. 32 is a plan schematic diagram that illustrates the electrode structures and the initial alignment of the liquid crystal molecules of the pixel of the liquid crystal display device of a ninth embodiment.

FIG. 33 is a cross-sectional schematic diagram that illustrates a cross section which corresponds to a line segment indicated by the one-dot chain line in FIG. 32.

FIG. 34 is a plan schematic diagram that illustrates the electrode structures and the initial alignment of the liquid crystal molecules of the pixel of the liquid crystal display device of a tenth embodiment.

FIG. 35 is a cross-sectional schematic diagram that illustrates a cross section which corresponds to a line segment indicated by the one-dot chain line in FIG. 34.

FIG. 36 is a plan schematic diagram that illustrates the electrode structures and the initial alignment of the liquid crystal molecules of the pixel of the liquid crystal display device of an eleventh embodiment.

FIG. 37 is a cross-sectional schematic diagram that illustrates a cross section which corresponds to a line segment indicated by the one-dot chain line in FIG. 36.

FIG. 38 is a cross-sectional schematic diagram that illustrates electrode structures and initial alignment of the liquid crystal molecules of a liquid crystal display device of a first comparative example.

FIG. 39 is a plan schematic diagram that illustrates the applied voltage to each electrode and the alignment of the liquid crystal molecules in the case of white display of the liquid crystal display device of the first comparative example.

FIG. 40 is a plan schematic diagram that illustrates the applied voltage to each of the electrodes and the alignment of the liquid crystal molecules in the case of black display of the liquid crystal display device of the first comparative example.

### DESCRIPTION OF EMBODIMENTS

The present invention will hereinafter be described further in detail with reference to drawings and raising embodiments. However, the present invention is not limited only to those embodiments. Herein, a pixel may be a picture element (sub-pixel) unless otherwise mentioned. The picture element (sub-pixel) is a region that displays any single color of red (R), green (G), blue (B), yellow (Y), or the like, for example. Further, a pair of substrates between which a liquid crystal layer is interposed is also referred to as upper and lower substrates. Between those, a substrate on a display surface side is also referred to as an upper substrate, and a substrate on the opposite side to the display surface is also referred to as a lower substrate. Further, among electrodes that are arranged on the substrates, an electrode on the display surface side is also referred to as an upper layer electrode, and an electrode on the opposite side to the display surface side is also referred to as a lower layer electrode.

Note that, in the embodiments, the same reference characters are given to members and portions that provide similar functions. Further, in the drawings, unless otherwise stated, (i) denotes a slit electrode that is provided on an upper layer (on the liquid crystal layer side) of the lower substrate, (ii) denotes a comb-shaped electrode on a lower layer (on the opposite side to the liquid crystal layer side) of the lower substrate, (iii) denotes another comb-shaped electrode on the lower layer of the lower substrate, (iv) denotes the upper layer electrode in an electrode layer in an FFS structure, and (v) denotes the lower layer electrode in the electrode layer in the FFS structure. Further, two-way arrows that are illustrated by broken lines in the drawings indicate lines of electrical force. A color filter, a black matrix, or the like that is not related to electric field control of liquid crystals is not illustrated.

Herein, an electrode on the lower substrate means at least one of the upper layer electrode (i), the lower layer electrode (ii), and a lower layer electrode (iii), (iiia), or (iiib).

Herein, the slit electrode represents an electrode provided with slits and usually includes plural linear electrode portions. Examples of a slit include a region in which the linear electrode is not formed.

Herein, the rise means a period in which display states are changed from a dark state (black display) to a bright state (white display). Further, the fall means a period in which display states are changed from the bright state (white display) to the dark state (black display). Further, initial alignment of the liquid crystals represents alignment of the liquid crystal molecules in a case where no voltage is applied (in the case of black display).

The above upper layer electrode (i), the lower layer electrode (ii), and the lower layer electrode (iii) may usually be set to different electric potentials at a threshold value voltage or higher. Herein, the threshold value voltage means the voltage value that provides a transmittance of 5% in a case where the transmittance of the bright state is set as 100%. In a case where different electric potential may be obtained at the threshold value voltage or higher, it is sufficient that a driving operation for obtaining different electric potentials at the threshold value voltage or higher may be realized. Accordingly, it is possible to properly control the electric field that is applied to the liquid crystal layer. As for a configuration that may provide different electric potentials, for example, in a case where the upper layer electrode (i) is a pixel electrode and the lower layer electrode (ii) and the lower layer electrode (iii) are common electrodes, a thin-film transistor element (TFT) is connected with the upper layer electrode (i), the liquid crystals are driven by an alternating current (AC driving) by applying an alternating-current voltage (AC voltage) while the value of the voltage is changed, and the liquid crystals may thereby be driven by the alternating current by applying an alternating-current voltage to the lower layer electrode (ii) and the lower layer electrode (iii) by another TFT. Alternatively, an alternating-current voltage is applied, by the TFT that corresponds to each line or every pixel, to the lower layer electrode (ii) and the lower layer electrode (iii) for which common connection is performed for each of the lines or common connection is performed in every pixel, and the liquid crystals may thereby be driven by the alternating current. Alternatively, a direct current voltage (DC voltage) is applied to the lower layer electrode (ii) and the lower layer electrode (iii) without using the TFT, and the liquid crystals may thereby be driven by the direct current (DC driving).

### First Embodiment

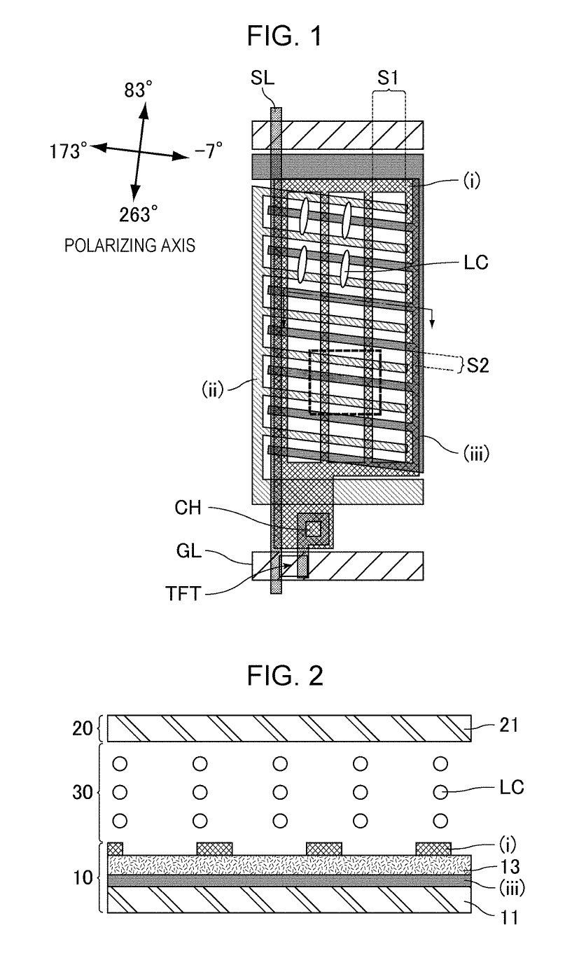

FIG. 1 is a plan schematic diagram that illustrates electrode structures and the initial alignment of the liquid crystal molecules of the pixel of the liquid crystal display device of the first embodiment.

The upper layer electrode (i) includes plural linear electrode portions in a plan view of a substrate main surface. The plural linear electrode portions are substantially parallel to each other, the slits that are substantially parallel to each other are respectively provided between the linear electrode portions. As described above, the upper layer electrode (i) that is provided with the slits is one preferable form of the present invention. Note that the upper layer electrode (i) may be a comb-shaped electrode instead of the slit electrode. The upper layer electrode (i) that is in a comb shape is also one preferable form of the present invention.

Each of the lower layer electrode (ii) and the lower layer electrode (iii) is configured with a stem portion and branch portions that extend from the stem portion in a plan view of the substrate main surface. The branch portions are plural linear electrode portions that are substantially parallel with each other. As described above, the lower layer electrode (ii) and the lower layer electrode (iii) that are in comb shapes are one preferable form of the present invention.

As described earlier, each of the upper layer electrode (i), the lower layer electrode (ii), and the lower layer electrode (iii) preferably has linear portions.

Note that the structures of the upper layer electrode (i), the lower layer electrode (ii), and the lower layer electrode (iii), which are illustrated in FIG. 1, are merely examples. Embodiments are not limited to those shapes, but electrodes in various structures may be used.

The extending direction of each of the lower layer electrode (ii) and the lower layer electrode (iii) is the direction at 83° with respect to the extending direction of the upper layer electrode (i). In other words, the two comb-shaped electrodes of the lower substrate are arranged such that the extending directions of the linear electrode portions as the branch portions intersect with the extending directions of the linear electrode portions of the upper layer electrode (i) at an angle of 83° in a plan view of the substrate main surface. The angle is preferably 30° or larger and smaller than 90°, still preferably 45° or larger, further preferably 60° or larger, and particularly preferably 75° or larger. Such electrode structures enable response times in the rise and in the fall to become shorter.

In the upper layer electrode (i), an electrode width L of the linear portion is 3.0 μm, and an electrode interval S1 between the linear portion and the linear portion that neighbor each other is 6.0 μm. The electrode width L is preferably 2 μm or more and 7 μm or less, for example. Further, the electrode interval S1 is preferably 2 μm or more and 14 μm or less, for example. The ratio between the electrode width L and the electrode interval S1 (L/S1) is preferably 0.1 to 1.5. A further preferable lower limit value of the ratio L/S1 is 0.2, and a further preferable upper limit value is 0.8.

In the branch portions of a pair of comb-shaped electrodes that is configured with the lower layer electrode (ii) and the lower layer electrode (iii), the electrode width L of the linear portion is 3.0 μm, and an electrode interval S2 between the linear portion and the linear portion that neighbor each other is 3.0 μm. The electrode width L is preferably 2 μm or more and 7 μm or less. Further, the electrode interval S2 is preferably 2 μm or more and preferably 7 μm or less. The ratio between the electrode width L and the electrode interval S2 (L/S2) is preferably 0.1 to 10. A lower limit value of the ratio L/S2 is still preferably 0.15, further preferably 0.2, and particularly preferably 0.25. An upper limit value of the ratio L/S2 is still preferably 5, further preferably 2, and particularly preferably 1.5.

Note that each of the electrode widths L and the electrode intervals S1 and S2 in each of the upper layer electrode (i), the lower layer electrode (ii), and the lower layer electrode (iii) is usually substantially the same in the pixel. However, in a case where the electrode width L or the electrode interval S1 or S2 is different in the pixel, it is preferable that any of the electrode widths L or the electrode intervals S1 and S2 is in the above range, and it is further preferable that all of those are in the above range.

Further, in FIG. 1, the linear electrode portion of the branch portions of the lower layer electrode (ii) of the lower substrate is arranged between the linear electrode portions of the branch portions of the lower layer electrode (iii).

The electrodes of the layers (the upper layer electrode (i), the lower layer electrode (ii), and the lower layer electrode (iii)) are arranged in the positional relationship illustrated in FIG. 1. As described above, a form in which the upper layer electrode (i) of the lower substrate is provided with slits and the lower layer electrode (ii) and the lower layer electrode (iii) of the lower substrate are in comb shapes is one preferable form of the present invention. Further, a form in which the upper layer electrode (i), the lower layer electrode (ii), and the lower layer electrode (iii) are in comb shapes is also one preferable form of the present invention.

In the first embodiment, two linear polarizers that have a polarizing axis illustrated in FIG. 1 are used. In the first embodiment, one linear polarizer is arranged on the outside (the opposite side to the liquid crystal layer side) of each of the upper and lower substrates. The arrangement of the linear polarizers is a crossed Nicol arrangement in which the polarizing axis of the linear polarizers on the upper and lower substrates is vertical or parallel to the major axis of the liquid crystal molecule in a case where no voltage is applied (an initial alignment direction of the liquid crystal molecule), and a liquid crystal display device of a normally black mode is provided. As described above, each of the upper and lower substrates preferably has the linear polarizer.

The upper layer electrode (i) is electrically connected with a drain electrode that extends from a thin-film transistor element TFT via a contact hole CH. At a timing that is selected by a gate bus line GL, a voltage that is supplied from a source driver via a source bus line SL is applied to the upper layer electrode (i) that drives the liquid crystals through the thin-film transistor element TFT.

FIG. 2 is a cross-sectional schematic diagram that illustrates a cross section which corresponds to a line segment indicated by the one-dot chain line in FIG. 1.

As illustrated in FIG. 2, the liquid crystal display device of the first embodiment is configured such that a lower substrate 10, a liquid crystal layer 30, and an upper substrate 20 are laminated in this order from a back surface side of the liquid crystal display device toward a viewed surface side.

As illustrated in FIG. 2, the liquid crystal display device of the first embodiment causes liquid crystal molecules LC to be horizontally aligned in a case where the electric potential difference between the electrodes of the upper and lower substrates is lower than a threshold value voltage (the liquid crystal molecules LC are aligned from the back toward the front of the cross section in FIG. 2).

Each of the lower layer electrode (ii) (not illustrated in FIG. 2) and the lower layer electrode (iii) of the lower substrate 10 is the comb-shaped electrode as described above, and the upper layer electrode (i) as the slit electrode is arranged on the lower layer electrode (ii) and the lower layer electrode (iii) via an insulating layer 13. An electrode for driving the liquid crystals is not provided on the upper substrate 20, but the electrodes for driving the liquid crystal are provided only on the lower substrate 10.

The dielectric constant of the insulating layer 13 is 6.9, and the average thickness thereof is 0.3 μm. Each of the insulating layers 13 is configured with a nitride film SiN. However, instead of that, an oxide film SiO₂, an acrylic resin, or the like, or a combination of those materials may be used.

A horizontal alignment film (not illustrated) is provided on each of the liquid crystal layer sides of the upper and lower substrates, and the horizontal alignment is performed such that the major axis of the liquid crystal molecule in a case where no voltage is applied is in the direction that is vertical to the extending directions of lower layer electrode (ii) and the lower layer electrode (iii). Further, the liquid crystal layer adjoins the upper layer electrode (i) via the horizontal alignment film. Examples of the horizontal alignment film include, as long as the liquid crystal molecules are horizontally aligned with respect to a film surface, an alignment film that is formed of an organic material (for example, an alignment film with dielectric constant ε=3 to 4), an alignment film that is formed of an inorganic material (for example, an alignment film with dielectric constant ε=5 to 7), a photo-alignment film that is formed of a photo-active material, an alignment film for which an alignment treatment is performed by rubbing or the like, and so forth. Note that the alignment film may be an alignment film for which the alignment treatment by a rubbing treatment or the like is not performed. The alignment film, for which the alignment treatment is not requested, such as the alignment film formed of an organic material, the alignment film formed of an inorganic material, or the photo-alignment film, is used, the cost may thereby be reduced by simplification of processes, and the reliability and yield may also be improved. Further, in a case where the rubbing treatment is performed, contamination of the liquid crystals due to entrance of impurities from rubbing cloth or the like, failure by point defects due to a foreign object, occurrence of display unevenness due to non-uniform rubbing in a liquid crystal panel, and so forth may occur. However, those disadvantages may be avoided.

The liquid crystals include liquid crystal molecules that are aligned in the horizontal direction with respect to the substrate main surface in a case where no voltage is applied. The alignment in the horizontal direction with respect to the substrate main surface may be alignment in which the liquid crystal molecules are considered as aligned substantially in the horizontal direction with respect to the substrate main surface and which provides the optical operation and effect in the technical field of the present invention. It is proper that the liquid crystals are substantially configured with the liquid crystal molecules that are aligned in the horizontal direction with respect to the substrate main surface in a case where no voltage is applied. The above “in a case where no voltage is applied” may be a case where a voltage is considered as substantially not applied in the technical field of the present invention. Such horizontal alignment type liquid crystals provide an advantageous scheme for obtaining wide viewing angle characteristics and so forth.

The dielectric anisotropy of a liquid crystal material in the liquid crystal layer 30 in the liquid crystal display device of the first embodiment is positive (dielectric anisotropy Δε=5.9, viscosity (rotational viscosity) γ1=89 cps, refractive index anisotropy Δn=0.109, and panel Re=350 nm). As described above, the liquid crystal layer that includes the liquid crystal molecules with positive dielectric anisotropy is one preferable form of the present invention. The liquid crystal molecule with the positive dielectric anisotropy is aligned in a regular direction in a case where the electric field is applied, alignment control is easy, and a quicker high-speed response may be performed. The dielectric anisotropy Δε of the liquid crystals is preferably three or more, still preferably four or more, and further preferably five or more. The dielectric anisotropy Δε of the liquid crystals is preferably 30 or less, still preferably 20 or less, and further preferably 10 or less. Herein, the dielectric anisotropy Δε of the liquid crystals means the dielectric anisotropy that is measured by an LCR meter.

In the first embodiment, the average thickness (cell gap) d_{LC} of the liquid crystal layer 30 is 3.2 μm.

Herein, the average thickness d_{LC} of the liquid crystal layer means the average thickness that is calculated by averaging the thicknesses of the whole liquid crystal layer in the liquid crystal display device.

d_{LC}×Δn is preferably 100 nm or more, still preferably 150 nm or more, and further preferably 200 nm or more. Further, d_{LC}×Δn is preferably 550 nm or less, still preferably 500 nm or less, and further preferably 450 nm or less.

A description will be made below about a driving method of the liquid crystals by using the liquid crystal display device according to this embodiment.

In this embodiment, driving that is capable of the high-speed response may be realized. Further, application methods of the voltage are switched, and two kinds of driving, which are the driving which is capable of the high-speed response and driving which realizes a higher transmittance than the above driving, may thereby be realized by the same configuration.

Herein, the driving that may realize the high-speed response will be referred to as a first driving scheme, and the driving that realizes a higher transmittance than that will be referred to as a second driving scheme.

Both of the first driving scheme and the second driving scheme perform gradation display by changing the voltage of the upper layer electrode (i).

In the first driving scheme, the voltage is applied to the lower layer electrode (ii), the lower layer electrode (iii) is set to 0 V, a lateral electric field is continuously generated, the voltage in accordance with the gradation is applied to the upper layer electrode (i), and the driving is thereby performed.

In the second driving scheme, both of the lower layer electrode (ii) and the lower layer electrode (iii) are set to 0 V, the voltage in accordance with the gradation is applied to the upper layer electrode (i), a fringe electric field is generated between the upper layer electrode (i) and the lower layer electrode (ii) and the lower layer electrode (iii), and the liquid crystals are thereby driven.

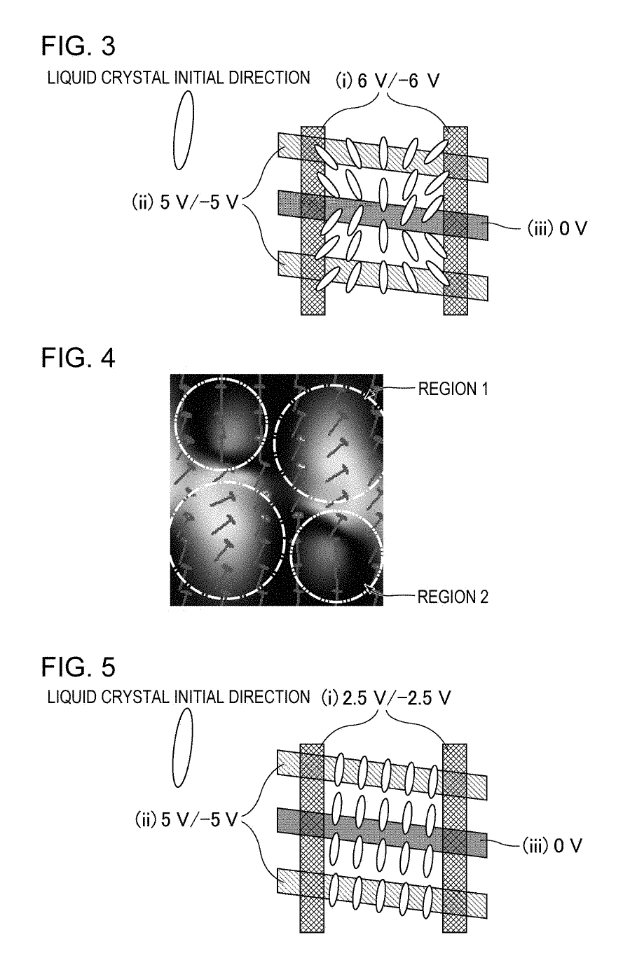

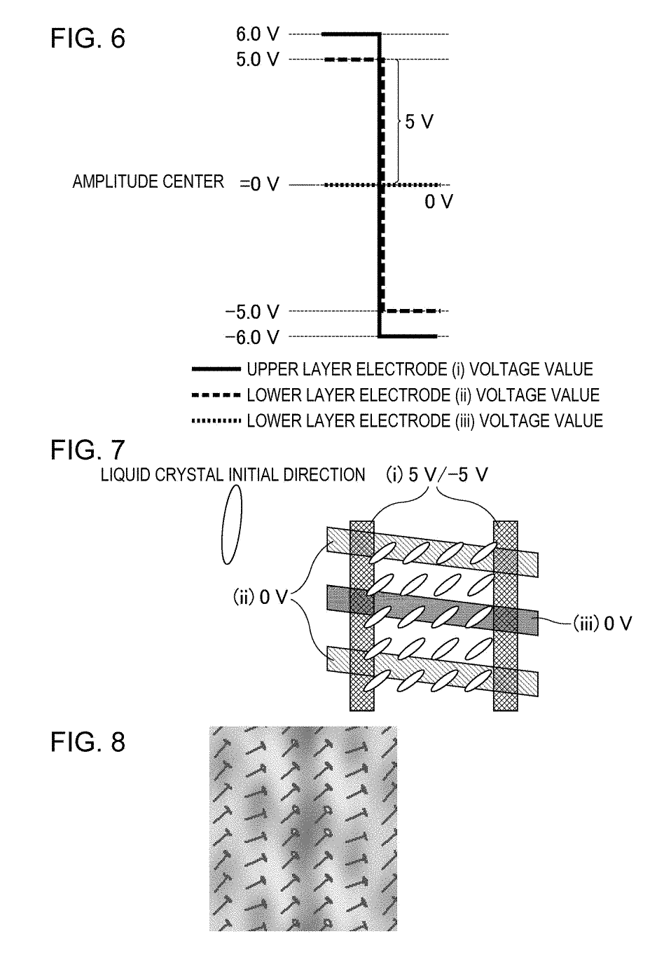

FIG. 3 is a plan schematic diagram that illustrates the applied voltage to each of the electrodes and the alignment of the liquid crystal molecules in a case of white display by the first driving scheme of the first embodiment. FIG. 4 is a simulation result that illustrates a director distribution and a transmittance distribution which correspond to FIG. 3. FIG. 5 is a plan schematic diagram that illustrates the applied voltage to each of the electrodes and the alignment of the liquid crystal molecules in a case of black display by the first driving scheme of the first embodiment. FIG. 6 is a voltage relationship diagram that illustrates the applied voltage to each of the electrodes in the case of white display by the first driving scheme of the first embodiment. Each of FIG. 3 to FIG. 5 illustrates the plane that corresponds to the portion surrounded by the broken lines in FIG. 1.

A detailed description will first be made about actions of the liquid crystal molecules in the rise (in the case of white display).

The lower layer electrode (iii) is continuously set to 0 V, the voltage, to which polarity inversion is performed while the amplitude center is set as 0 V, is applied to the lower layer electrode (ii), and the lateral electric field is thereby continuously generated. Note that the voltage value that is applied to the lower layer electrode (ii) is continuously a regular value. Based on that, the voltage to which the polarity inversion is performed is applied to the upper layer electrode (i), an electric field that causes the liquid crystal molecules to rotate in alternately different directions in the horizontal plane is generated, and the electric field causes the liquid crystal molecules to be aligned in bend alignment and splay alignment in a plane. In a case of white gradation display in the first driving scheme of this embodiment, 6 V/−6 V are applied to the upper layer electrode (i), and 5 V/−5 V are applied to the lower layer electrode (ii). As it may be understood by seeing the transmittance distribution diagram by the simulation, the liquid crystal molecules rotate in different directions in a region 1 and a region 2, which are illustrated in FIG. 4, and it may be understood that the region 1 and the region 2 are alternately present.

In the first driving scheme, the liquid crystal molecules rotate in alternately different directions in the horizontal plane. That is, the liquid crystal molecules rotate clockwise in the horizontal plane in the region 1 (first region) illustrated in FIG. 4, and the liquid crystal molecules rotate counterclockwise in the horizontal plane in the region 2 (second region). In other words, in a plan view of the upper and lower substrates, the liquid crystal molecules do not rotate in one direction but in two different directions in the horizontal plane in each of the portions between the linear electrodes of the upper layer electrode (i) (in the region that overlaps with the slits of the upper layer electrode (i)), between the linear electrodes as the branch portions of the lower layer electrode (ii), and between the linear electrodes as the branch portions of the lower layer electrode (iii).

The voltage is continuously applied to the lower layer electrode (ii), and a strong electric field is thereby applied to all the regions in the horizontal plane in a case of a rise response. Thus, the rise response is performed at a high speed.

In the case of white display of the first driving scheme, the electric potential of each of the electrodes of the lower substrate is set such that the liquid crystal molecules rotate in alternately different directions in the horizontal plane. Specifically, as described above, the electric potentials of the upper layer electrode (i) are set to 6 V/−6 V, the electric potentials of the lower layer electrode (ii) are set to 5 V/−5 V, and the electric potential difference between the upper layer electrode (i) and the lower layer electrode (ii) is set to 1 V. The electric potential difference between the upper layer electrode (i) and the lower layer electrode (ii) may be set to 8 V or lower, for example, still preferably 5 V or lower, and further preferably 4 V or lower.

A preferable electric potential difference between the upper layer electrode (i) and the lower layer electrode (iii) is preferably 2 to 12 V, still preferably 3 to 11 V, and further preferably 3 to 10 V.

A description will next be made about actions of the liquid crystal molecules in the fall (in the case of black display).

The voltages applied to the upper layer electrode (i) are lowered, and the liquid crystal molecules thereby react to the lateral electric field by the lower layer electrode (ii) and the lower layer electrode (iii) and forcibly rotate in the initial alignment direction by the electric field. Further, the restoring force of the liquid crystal molecules that are in the bend alignment and the splay alignment in the horizontal plane in the case of white display simultaneously works and further accelerates the response. In a case of black gradation display in the first driving scheme of this embodiment, 2.5 V/−2.5 V are applied to the upper layer electrode (i), and 5 V/−5 V are applied to the lower layer electrode (ii).

In the first driving scheme, the voltages (5 V/−5 V in FIG. 5) are continuously applied to the lower layer electrode (ii) in a case of a fall response. Thus, in a case where the voltages of the upper layer electrode (i) are turned off (lowered), the liquid crystal molecules forcibly rotate in the direction for returning to the initial alignment by the electric field that is generated between the lower layer electrode (ii) and the lower layer electrode (iii). In addition, in a case of the first driving scheme, the bend alignment and the splay alignment are generated in the horizontal plane, and a large restoring force due to elastic strain induced by the bend alignment and the splay alignment works. Accordingly, the fall response is also performed at a high speed. Further, in the first driving scheme, at least two successive regions in which the liquid crystal molecules rotate in different directions in a plane are alternately present. As described above, it is preferable that two or more successive regions in which the liquid crystal molecules rotate in different directions are present in a plane.

In FIG. 5, the electric potentials of the upper layer electrode (i) are set to 2.5 V/−2.5 V. As described above, except for lowering or turning off the voltages of the pixel electrode (the upper layer electrode (i) in the first embodiment) from the voltages at the maximum transmittance, the electric potentials or the like of the other electrodes (the lower layer electrode (ii) and the lower layer electrode (iii) in the first embodiment) may be set to the same as the case of white display in the first driving scheme, and a preferable range or the like of the electric potentials or the like is similar to the case of white display of the first driving scheme. For example, in the first embodiment, in both of the cases of white display and black display, the lower layer electrode (ii) of the lower substrate is set to 5 V/−5 V, and the lower layer electrode (iii) is set to 0 V. As described above, in the liquid crystal display device of the present invention, the lower layer electrode (ii) and the lower layer electrode (iii) of the lower substrate are preferably set to regular voltage values in both of the cases of white display and black display.

In a voltage application method to each of the electrodes in the above-described first driving scheme, the upper layer electrode (i) is the pixel electrode, the voltage applied to the upper layer electrode (i) is changed, the voltage of a regular magnitude is applied to the lower layer electrode (ii), and the lower layer electrode (iii) is set to 0 V. Such a voltage application method is one preferable form in the liquid crystal display device of the present invention. However, as long as the operation and effect of the present invention are provided, the up-down arrangement relationship of the electrodes may appropriately be changed.

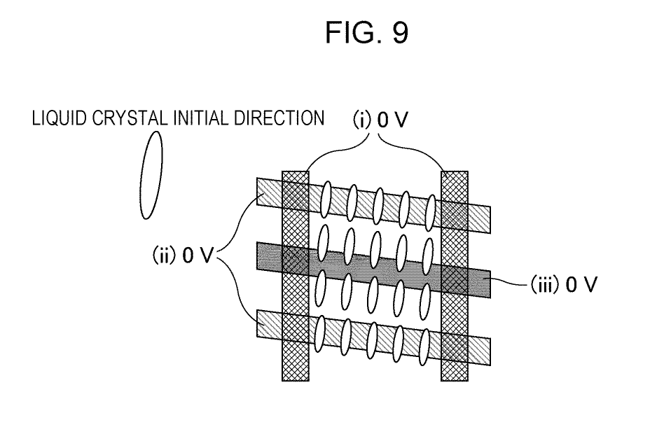

FIG. 7 is a plan schematic diagram that illustrates the applied voltage to each of the electrodes and the alignment of the liquid crystal molecules in the case of white display by the second driving scheme of the first embodiment. FIG. 8 is a simulation result that illustrates the director distribution and the transmittance distribution which correspond to FIG. 7. FIG. 9 is a plan schematic diagram that illustrates the applied voltage to each of the electrodes and the alignment of the liquid crystal molecules in the case of black display by the second driving scheme of the first embodiment.

Each of FIG. 7 to FIG. 9 illustrates the plane that corresponds to the portion surrounded by the broken lines in FIG. 1.

A detailed description will first be made about actions of the liquid crystal molecules in the rise (in the case of white display).

While both of the lower layer electrode (ii) and the lower layer electrode (iii) are set to 0 V, in addition, the voltage to which polarity inversion is performed is applied to the upper layer electrode (i), the fringe electric field is thereby generated between the upper layer electrode (i) and the lower layer electrode (ii) and the lower layer electrode (iii), and the liquid crystal molecules react to the electric field and rotate in the same direction. In the case of white gradation display in the second driving scheme of this embodiment, 5 V/−5 V are applied to the upper layer electrode (i).

As it may be understood by seeing the transmittance distribution diagram (FIG. 8) by the simulation, the liquid crystal molecules rotate in the same direction, and a high transmittance is obtained as the whole compared to the first driving scheme.

In the case of white display of the second driving scheme, although the electric potential of the upper layer electrode (i) changes in accordance with the display, an upper limit of the electric potential is preferably 10 V, still preferably 8 V, and further preferably 7 V.

The electric potentials of the lower layer electrode (ii) and the lower layer electrode (iii) may be set to lower than the threshold value voltage.

A description will next be made about actions of the liquid crystal molecules in the fall (in the case of black display).

The voltage applied to the upper layer electrode (i) is turned off, and the liquid crystal molecules thereby rotate so as to return toward an alignment treatment direction (anchoring) by the restoring force of the liquid crystal molecules. In the case of black display in the second driving scheme of this embodiment, 0 V is applied to the upper layer electrode (i). The applied voltage to each of the other electrodes (the lower layer electrode (ii) and the lower layer electrode (iii)) is similar to the case of white display of the second driving scheme and is application of 0 V. In the case of black display of the second driving scheme, the electric potentials of the upper layer electrode (i), the lower layer electrode (ii), and the lower layer electrode (iii) may be set to lower than the threshold value voltage.

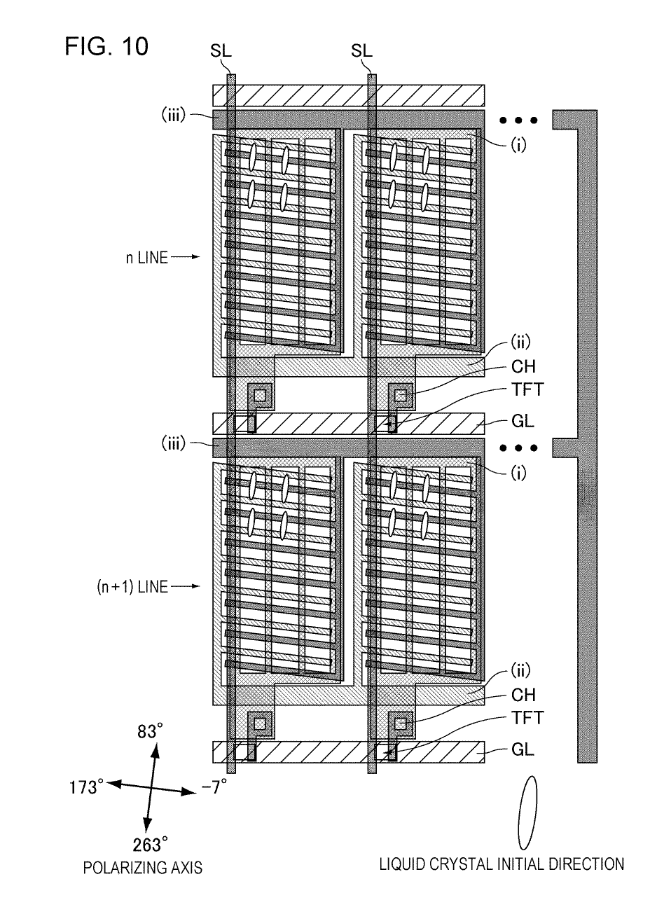

FIG. 10 is a plan schematic diagram that illustrates one example of a pixel layout in a case where the liquid crystal display device of the first embodiment is driven with the TFTs. Note that FIG. 10 is one example, and the electrode structures, wiring, or the like is not limited to this shape.

Because the voltage applied to the lower layer electrode (ii) is different between the first driving scheme and the second driving scheme, scan driving has to be performed for each line (for example, a gate bus line).

Meanwhile, because the same regular voltage value may be applied to the lower layer electrode (iii) in both of the first driving scheme and the second driving scheme, as illustrated in FIG. 10, the electrodes for all the lines may be made common electrodes. In other words, the lower layer electrode (iii) may be made the common electrode in every pixel.

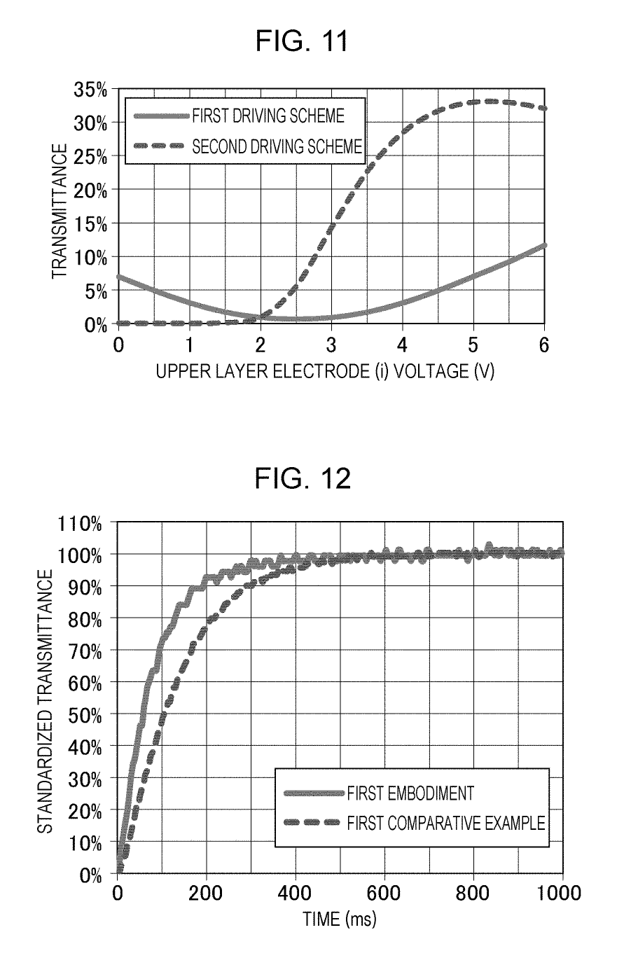

FIG. 11 is a graph that represents respective voltage-transmittance (V-T) characteristics of the upper layer electrode (i) of the first driving scheme and the second driving scheme of the first embodiment.

The voltage-transmittance (V-T) characteristics in the first driving scheme and the second driving scheme of the first embodiment were calculated by using LCD Master 3D, and whether effects for transmittance enhancement by switching from the first driving scheme to the second driving scheme were present was examined. The maximum transmittance of the second driving scheme (the maximum transmittance of 32.9%) is as high as 2.86 times compared to the first driving scheme (the maximum transmittance 11.5%). It was found that the transmittance was improved by switching from the first driving scheme to the second driving scheme.

In the first embodiment, the lower substrate has two layers of the electrodes. As described above, a form in which the electrodes of the lower substrate are configured with the electrode provided with the slits in the upper layer and the pair of comb-shaped electrodes in the lower layers is one preferable form in the liquid crystal display device of the present invention. However, because a liquid crystal display device that generates the electric field in accordance with the first driving scheme may provide the effects of the present invention, for example, a pair of comb-shaped electrodes may be used in the upper layer electrode (i) of the lower substrate instead of the slit electrode. In a case where the pair of comb-shaped electrodes is used, the liquid crystal molecules are caused to rotate in the horizontal plane by generating the lateral electric field between the pair of comb-shaped electrodes. The relationship between the alignment direction of the liquid crystal molecules and the electrode arrangement may be considered by replacing the extending direction of the slit electrode included in an FFS electrode by the extending directions of the pair of comb-shaped electrodes.

In view of an improvement effect of the transmittance, a thin-film transistor element that includes oxide semiconductor is preferably used for the thin-film transistor element in the liquid crystal display device of the first embodiment. The oxide semiconductor exhibits higher carrier mobility than amorphous silicon. Accordingly, the area of the transistor that occupies one pixel may be made small, the aperture ratio thus increases, and it is possible to enhance the light transmittance for one pixel. Therefore, the thin-film transistor element that includes oxide semiconductor is used, and a transmittance improvement effect as an effect of the present invention may thereby be more significantly obtained. That is, the lower substrate preferably includes the thin-film transistor element, and the thin-film transistor element preferably includes oxide semiconductor.

The upper and lower substrates included in the liquid crystal display device of the first embodiment are usually a pair of substrates between which the liquid crystals are interposed, have an insulating substrate such as glass or resin as a parent substance, for example, and are formed by assembling wiring, electrodes, a color filter, and so forth on the insulating substrate as necessary.

Note that the liquid crystal display device of the first embodiment may appropriately include members (for example, a light source and so forth) that are included in a usual liquid crystal display device. Further, the liquid crystal display device of the first embodiment preferably drives the liquid crystals by an active matrix driving scheme. The same applies to the embodiments described later.

The liquid crystal display device of the first embodiment may be employed for liquid crystal display devices of any of a transmissive type, a reflective type, and a transflective type. The same applies to the embodiments described later.

### COMPARISON OF RESPONSE CHARACTERISTICS BETWEEN FIRST EMBODIMENT AND FIRST COMPARATIVE EXAMPLE

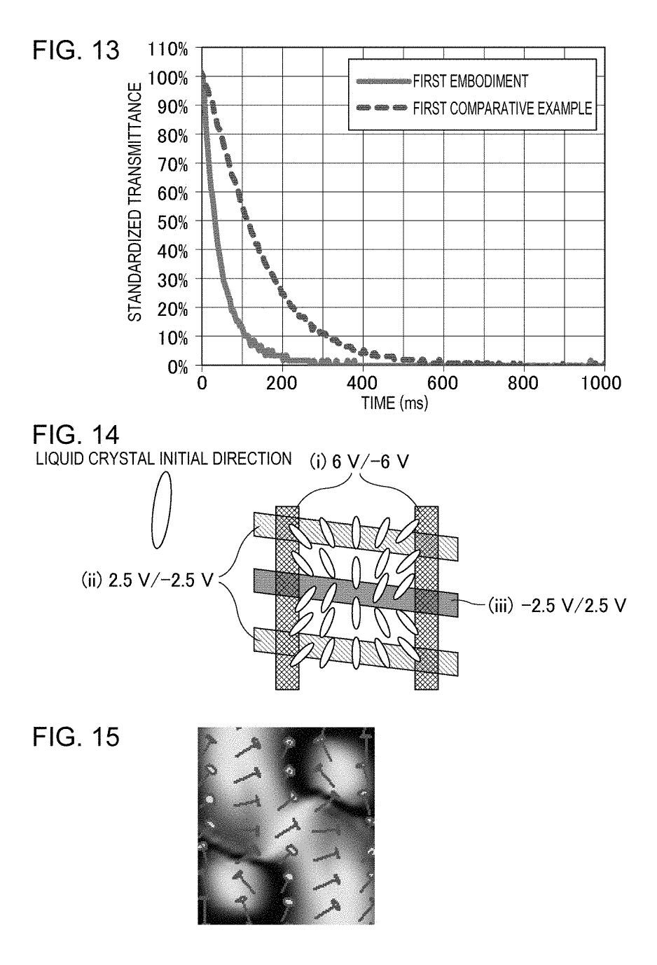

FIG. 12 is a graph that represents standardized transmittances with respect to time in the rises of the first embodiment and a first comparative example. FIG. 13 is a graph that represents the standardized transmittances with respect to time in the falls of the first embodiment and the first comparative example. Note that the first comparative example is related to a liquid crystal display device of an FFS mode in related art, and a configuration of the first comparative example will be described later.

FIG. 12 and FIG. 13 represent results of response simulations of the first embodiment and the first comparative example. It may be understood that the first embodiment is quicker than the first comparative example about both of the rise response and the fall response.

The response time/transmittance is calculated as an index for confirming the extent of compatibility of the high-speed response and high transmittance. As this value is smaller, the compatibility between the high-speed response and the high transmittance is higher.

Because the response time/transmittance of the first embodiment is a smaller value than the first comparative example, it may be considered that the first embodiment as the driving in which the compatibility between the high-speed response and the high transmittance may be realized is superior to the first comparative example.

### Second Embodiment

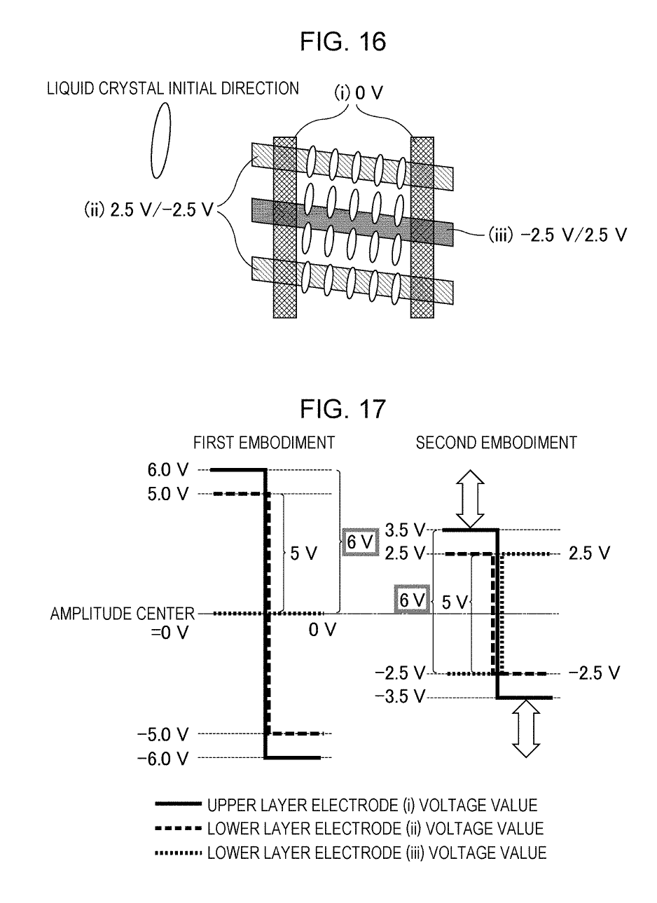

FIG. 14 is a plan schematic diagram that illustrates the applied voltage to each of the electrodes and the alignment of the liquid crystal molecules in the case of white display by the first driving scheme of a second embodiment. FIG. 15 is a simulation result that illustrates the director distribution and the transmittance distribution which correspond to FIG. 14. FIG. 16 is a plan schematic diagram that illustrates the applied voltage to each of the electrodes and the alignment of the liquid crystal molecules in the case of black display by the first driving scheme of the second embodiment. FIG. 17 is a voltage relationship diagram that illustrates the applied voltage to each of the electrodes in the case of white display by the first driving scheme of each of the first embodiment and the second embodiment. Each of FIG. 14 to FIG. 16 illustrates the plane that corresponds to the portion surrounded by the broken lines in FIG. 1.

The second embodiment is different from the first embodiment in a point that the voltage values that are applied to the lower layer electrode (ii) and the lower layer electrode (iii) in the first driving scheme are respectively set to 5 V/−5 V and 0 V in the first embodiment but are set to 2.5 V/−2.5 V and -2.5 V/2.5 V in the second embodiment. Further, in this case, the voltage values applied to the upper layer electrode (i) in the case of black display and the case of white display are 0 V and 6 V/−6 V, respectively.

FIG. 17 is an applied voltage relationship diagram of the first driving scheme of the first embodiment and the second embodiment. The voltage values of the upper layer electrode (i) in the white display of the first driving scheme of the first embodiment are 6 V/−6 V. Meanwhile, because the voltage value of the lower layer electrode (iii) is 0 V, the voltage difference between both of the electrodes is 6 V. In the second embodiment, the voltages are applied to the lower layer electrode (iii) while the polarity inversion with −2.5 V/2.5 V is performed. Thus, in order to obtain the same transmittance in the white display in the first embodiment, that is, in order to set the voltage difference between the upper layer electrode (i) and the lower layer electrode (iii) to 6 V, the voltage values applied to the upper layer electrode (i) may be 3.5 V/−3.5 V. Further, in this case, the voltage difference of 1 V between the upper layer electrode (i) and the lower layer electrode (ii) is equivalent between the first embodiment and the second embodiment, and the relative voltage relationship between the upper layer electrode (i) and the lower layer electrode (iii) is also equivalent. In FIG. 17, the voltage differences between the upper layer electrode (i) and the lower layer electrode (iii) are indicated while being surrounded by frames.

A preferable electric potential difference between the upper layer electrode (i) and the lower layer electrode (ii) and a preferable electric potential difference between the upper layer electrode (i) and the lower layer electrode (iii) are similar to the electric potential differences described above in the first embodiment. Other preferable configurations are similar to the configurations described above in the first embodiment.

Accordingly, in a case where the voltage values applied to the upper layer electrode (i) in the case of white display in the second embodiment are set to the same 6 V/−6 V as the first embodiment, a higher transmittance may be obtained in the case of white display of the first driving scheme of the second embodiment than in the case of white display of the first embodiment (see Table 1). As described above, in view of obtaining a higher transmittance, the electric potential difference between the upper layer electrode (i) and the lower layer electrode (iii) is particularly preferably 7.5 V or higher. This fact may be understood by seeing simulation transmittance distribution diagrams (FIG. 8 and FIG. 15) in the first embodiment and the second embodiment.

Table 1 represents the transmittances in the case of white display of the first driving scheme and the second driving scheme in the first and second embodiments. It may be understood that in either one of the embodiments, the transmittance of the second driving scheme is high compared to the transmittance of the first driving scheme. The second driving scheme of the second embodiment is a case where the voltage is applied to each of the electrode in a similar manner to the second driving scheme of the first embodiment.

TABLE 1

| | Transmittance (%) | |
|---|---|---|
| | First driving scheme | Second driving scheme |
| First embodiment | 11.5 | 32.9 |
| Second embodiment | 19.5 | 32.9 |

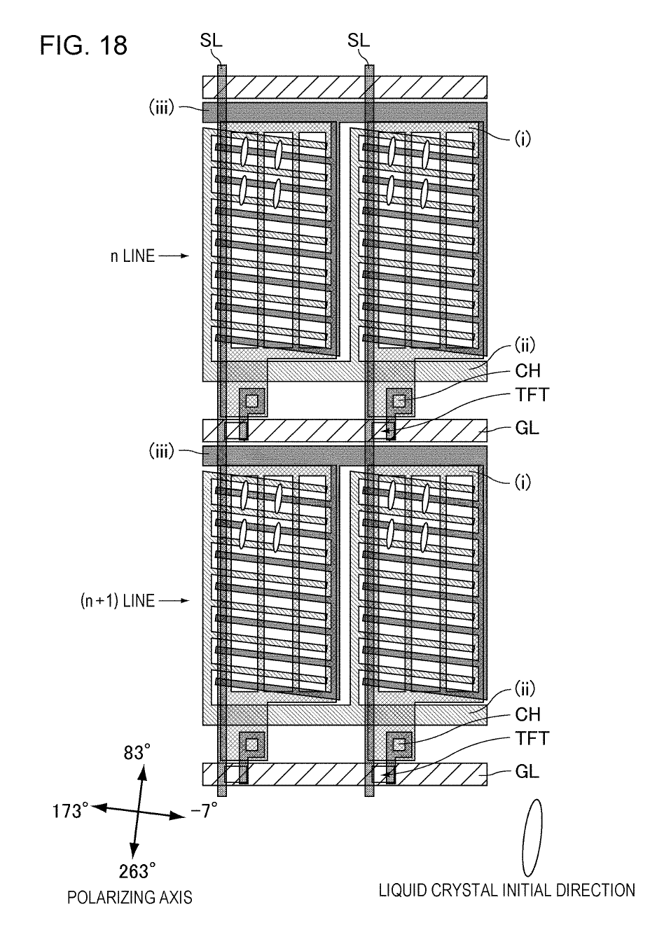

FIG. 18 is a plan schematic diagram that illustrates one example of the pixel layout in a case where the liquid crystal display device of the second embodiment is driven with the TFTs. Note that FIG. 18 is one example, and the electrode structures, wiring, or the like is not limited to this shape.

Because the second embodiment is different from the first embodiment and the voltages applied to both of the lower layer electrode (ii) and the lower layer electrode (iii) are different between the first driving scheme and the second driving scheme, the scan driving is preferably performed for each line, for example, in both of the lower layer electrodes.

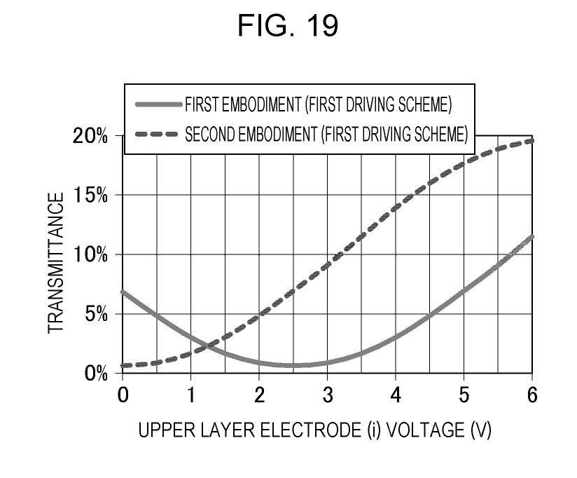

FIG. 19 is a graph that represents the respective voltage-transmittance (V-T) characteristics of the upper layer electrode (i) in the first driving scheme of the first embodiment and the second embodiment.

From the graph (actual measurement) that is illustrated in FIG. 19 and represents the V-T characteristics, it may be understood that the second embodiment may realize a high transmittance compared to the first embodiment in the comparison by the first driving scheme.

The V-T characteristic was measured by using luminance colorimeter BM-5A from TOPCON CORPORATION under an environment of a darkroom and an ordinary temperature. The measurement was performed while the voltage of the upper layer electrode (i) was changed by 0.5 V from 0 to 6 V.

That is, also in the configuration of the second embodiment, the first driving scheme may form an electric field that causes the liquid crystal molecules to rotate in alternately different directions in the horizontal plane. It is possible to perform both of the rise and the fall at high speeds and to realize compatibility between a wide viewing angle and the high-speed response. Further, a higher transmittance than the first embodiment may be realized. Further, similarly to the FFS mode, the second driving scheme may form the electric field that causes the liquid crystal molecules to rotate in the same direction in the whole region and may realize compatibility between the wide viewing angle and the high transmittance.

### COMPARISON OF RESPONSE CHARACTERISTICS BETWEEN FIRST AND SECOND EMBODIMENTS AND FIRST COMPARATIVE EXAMPLE

Table 2 represents the response times and the transmittances of the first and second embodiments and the first comparative example. Response measurement was conducted at a panel temperature of −30° C.

An item of Tr+Td represents the value of Tr+Td given that the response time in which the transmittance changes from 10% to 90% is denoted as Tr and the response time in which the transmittance changes from 90% to 10% is denoted as Td.

TABLE 2

| | | | Tr + Td |
|---|---|---|---|
| | Tr + Td | Transmittance | (ms)/Transmittance |
| | (ms)*¹ | (%)*² | (%) |
| First embodiment | 274 | 32.9 | 8.328 |
| Second embodiment | 222 | 32.9 | 6.748 |
| First comparative | 560 | 33.1 | 16.918 |
| example | | | |

*¹The response times of the first and second embodiments are values in the first driving scheme.
*²The transmittances of the first and second embodiments are values in the second driving scheme.

As illustrated in Table 2, because the response time/transmittance of the second embodiment is a smaller value than the first comparative example described later, similarly to the first embodiment, it may be considered that the second embodiment as the driving in which the compatibility between the high-speed response and the high transmittance may be realized is superior to the first comparative example.

Accordingly, in the first driving scheme of the first and second embodiments, the electric field that causes the liquid crystal molecules to rotate in alternately different directions in the horizontal plane. It is possible to perform both of the rise and the fall at high speeds and to realize the compatibility between the wide viewing angle and the high-speed response. Similarly to the FFS mode, the second driving scheme of the first and second embodiments may form the electric field that causes the liquid crystal molecules to rotate in the same direction in the whole region and may realize the compatibility between the wide viewing angle and the high transmittance.

### Third Embodiment

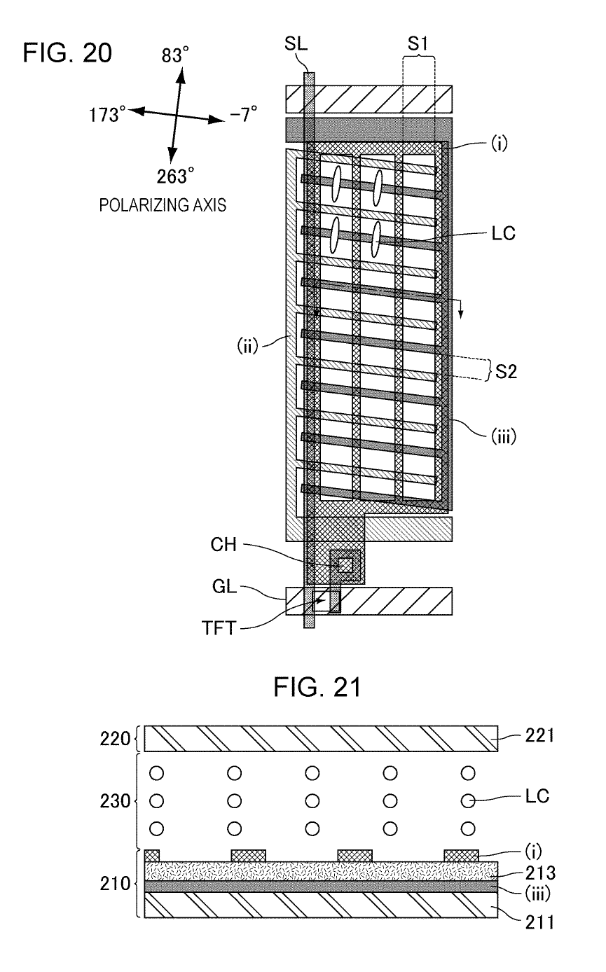

FIG. 20 is a plan schematic diagram that illustrates the electrode structures and the initial alignment of the liquid crystal molecules of the pixel of the liquid crystal display device of a third embodiment. FIG. 21 is a cross-sectional schematic diagram that illustrates a cross section which corresponds to a line segment indicated by the one-dot chain line in FIG. 20.

The third embodiment is different from the first embodiment in a point that in the lower layer electrode (ii) and the lower layer electrode (iii), the electrode interval S2 between the linear portion and the linear portion that neighbor each other is set to 6 μm. A preferable configuration other than the shape of the lower layer electrodes of the lower substrate and a preferable voltage application method are similar to the preferable configuration and the preferable voltage application method of the first embodiment.

### Fourth Embodiment

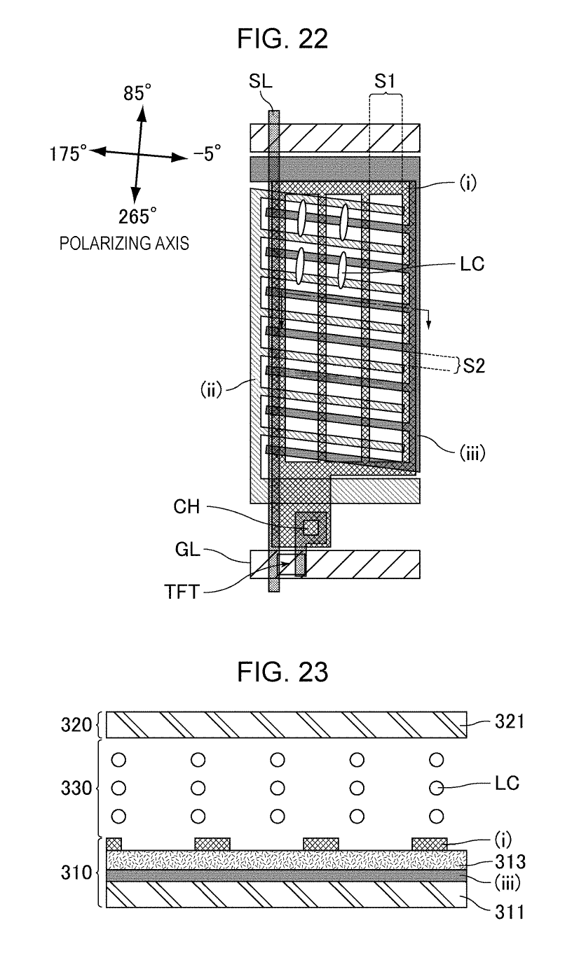

FIG. 22 is a plan schematic diagram that illustrates the electrode structures and the initial alignment of the liquid crystal molecules of the pixel of the liquid crystal display device of a fourth embodiment. FIG. 23 is a cross-sectional schematic diagram that illustrates a cross section which corresponds to a line segment indicated by the one-dot chain line in FIG. 22.

The fourth embodiment is different from the first embodiment in a point that the extending direction of each of the lower layer electrode (ii) and the lower layer electrode (iii) is set to 85° with respect to the extending direction of the upper layer electrode (i). Similarly to the first embodiment, the initial alignment of the liquid crystals is set vertically to the extending direction of each of the lower layer electrode (ii) and the lower layer electrode (iii).

### Fifth Embodiment

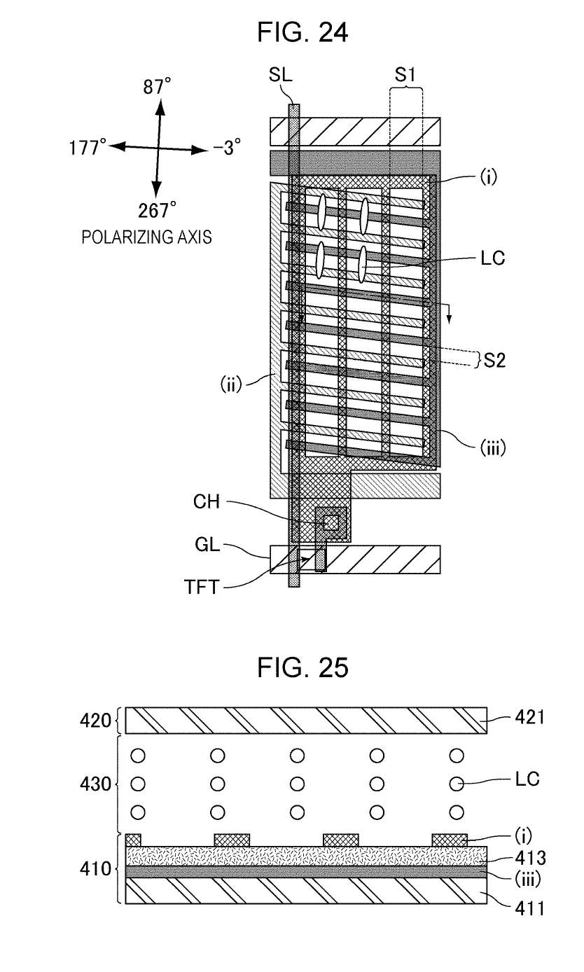

FIG. 24 is a plan schematic diagram that illustrates the electrode structures and the initial alignment of the liquid crystal molecules of the pixel of the liquid crystal display device of a fifth embodiment. FIG. 25 is a cross-sectional schematic diagram that illustrates a cross section which corresponds to a line segment indicated by the one-dot chain line in FIG. 24.

The fifth embodiment is different from the first embodiment in a point that the extending directions of the lower layer electrodes (ii) and (iii) are set to 87° with respect to the extending direction of the upper layer electrode (i). Similarly to the first embodiment, the initial alignment of the liquid crystals is set vertically to the extending direction of each of the lower layer electrode (ii) and the lower layer electrode (iii).

### Sixth Embodiment

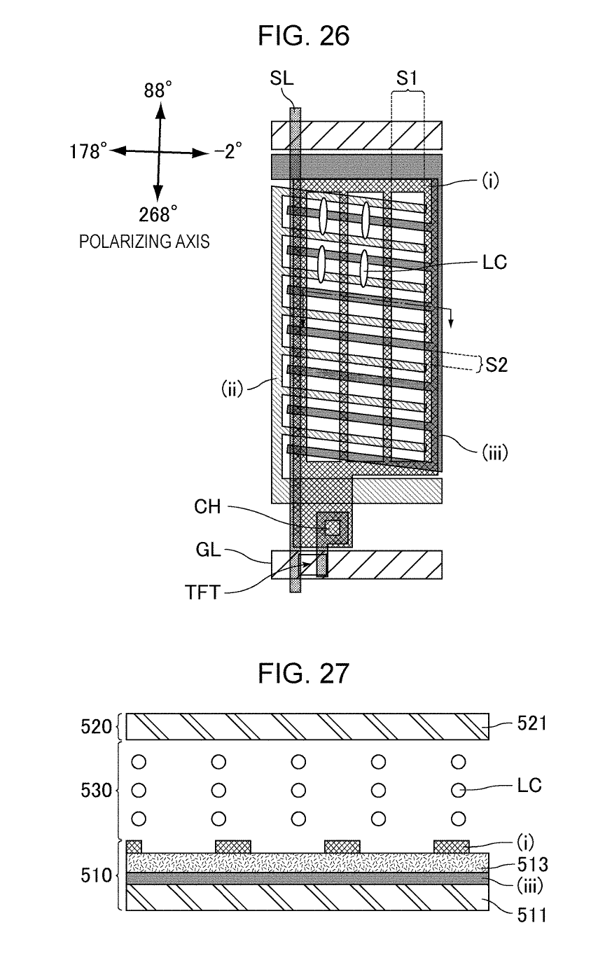

FIG. 26 is a plan schematic diagram that illustrates the electrode structures and the initial alignment of the liquid crystal molecules of the pixel of the liquid crystal display device of a sixth embodiment. FIG. 27 is a cross-sectional schematic diagram that illustrates a cross section which corresponds to a line segment indicated by the one-dot chain line in FIG. 26.

The sixth embodiment is different from the first embodiment in a point that the extending direction of each of the lower layer electrode (ii) and the lower layer electrode (iii) is set to 88° with respect to the extending direction of the upper layer electrode (i). Similarly to the first embodiment, the initial alignment of the liquid crystals is set vertically to the extending direction of each of the lower layer electrode (ii) and the lower layer electrode (iii).

### Seventh Embodiment

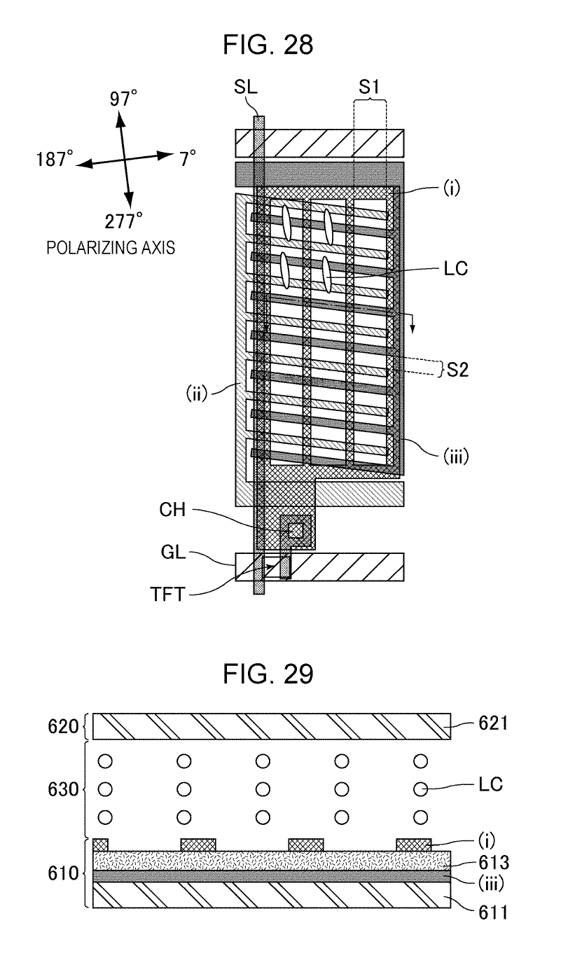

FIG. 28 is a plan schematic diagram that illustrates the electrode structures and the initial alignment of the liquid crystal molecules of the pixel of the liquid crystal display device of a seventh embodiment. FIG. 29 is a cross-sectional schematic diagram that illustrates a cross section which corresponds to a line segment indicated by the one-dot chain line in FIG. 28.

The seventh embodiment is different from the first embodiment in a point that the initial alignment of the liquid crystal molecules is set to 7° in the rightward rotation with respect to the extending direction of the upper layer electrode (i) in the first embodiment but is set to 7° in the leftward rotation with respect to the extending direction of the upper layer electrode (i) in the seventh embodiment. The extending direction of each of the lower layer electrode (ii) and the lower layer electrode (iii) is the same as the first embodiment, is at 83° with respect to the extending direction of the upper layer electrode (i) in a plan view of the substrate main surface, and as a result forms an angle of 76° to the initial alignment of the liquid crystals.

### Eighth Embodiment

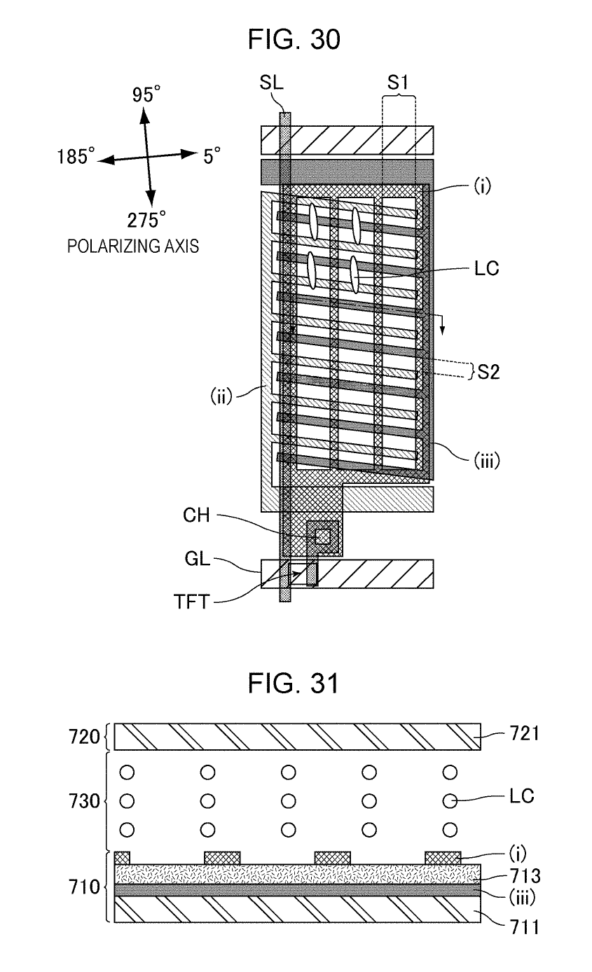

FIG. 30 is a plan schematic diagram that illustrates the electrode structures and the initial alignment of the liquid crystal molecules of the pixel of the liquid crystal display device of an eighth embodiment. FIG. 31 is a cross-sectional schematic diagram that illustrates a cross section which corresponds to a line segment indicated by the one-dot chain line in FIG. 30.

The eighth embodiment is different from the fourth embodiment in a point that the initial alignment of the liquid crystal molecules is set to 5° in the rightward rotation with respect to the extending direction of the upper layer electrode (i) in the fourth embodiment but is set to 5° in the leftward rotation with respect to the extending direction of the upper layer electrode (i) in the eighth embodiment. The extending direction of each of the lower layer electrode (ii) and the lower layer electrode (iii) is the same as the fourth embodiment, is at 85° with respect to the extending direction of the upper layer electrode (i) in a plan view of the substrate main surface, and as a result forms an angle of 80° to the initial alignment of the liquid crystals.

### Ninth Embodiment

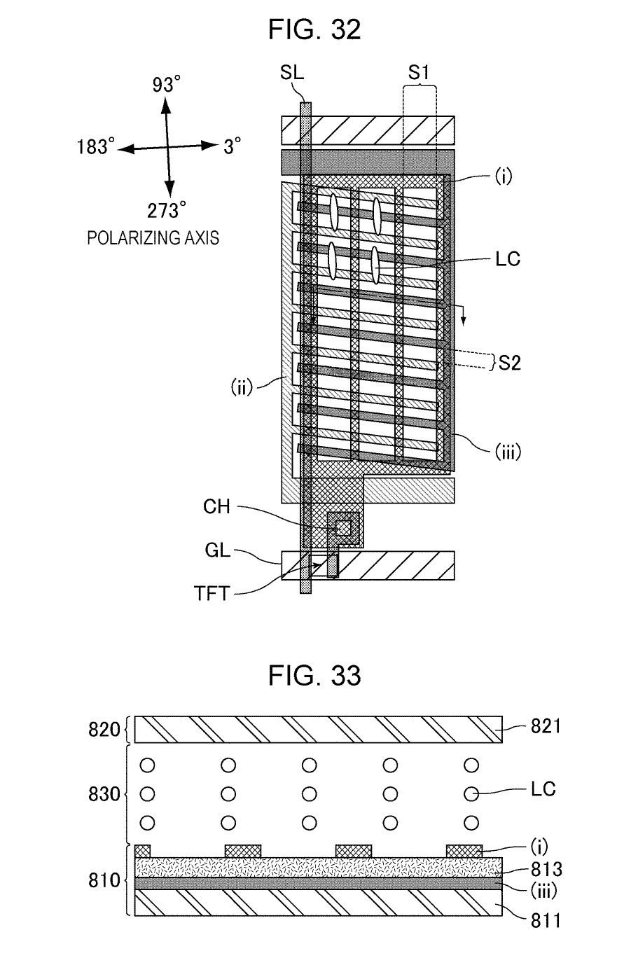

FIG. 32 is a plan schematic diagram that illustrates the electrode structures and the initial alignment of the liquid crystal molecules of the pixel of the liquid crystal display device of an ninth embodiment. FIG. 33 is a cross-sectional schematic diagram that illustrates a cross section which corresponds to a line segment indicated by the one-dot chain line in FIG. 32.

The ninth embodiment is different from the fifth embodiment in a point that the initial alignment of the liquid crystal molecules is set to 3° in the rightward rotation with respect to the extending direction of the upper layer electrode (i) in the fifth embodiment but is set to 3° in the leftward rotation with respect to the extending direction of the upper layer electrode (i) in the ninth embodiment. The extending direction of each of the lower layer electrode (ii) and the lower layer electrode (iii) is the same as the fifth embodiment, is at 87° with respect to the extending direction of the upper layer electrode (i) in a plan view of the substrate main surface, and as a result forms an angle of 84° to the initial alignment of the liquid crystals.

### Tenth Embodiment

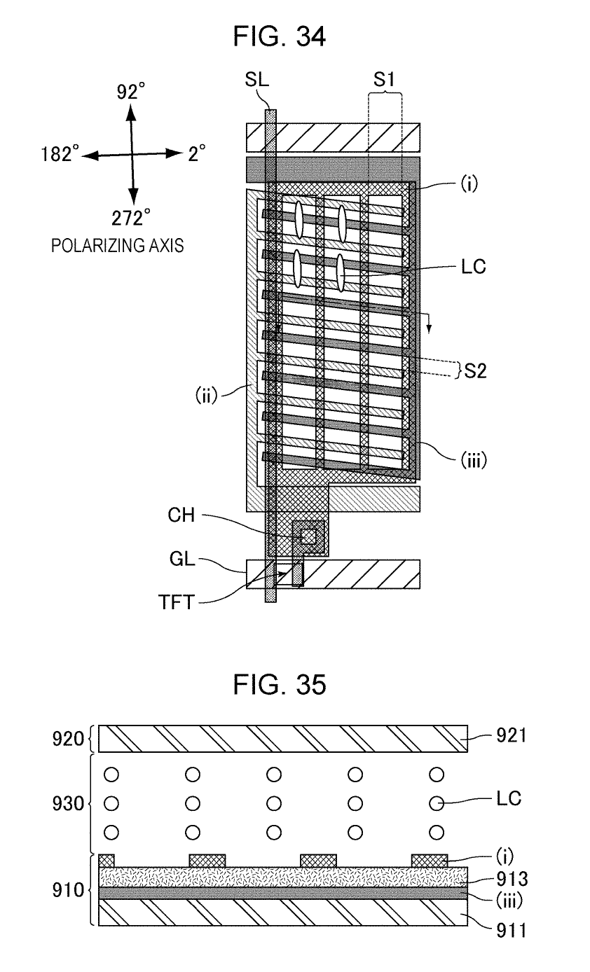

FIG. 34 is a plan schematic diagram that illustrates the electrode structures and the initial alignment of the liquid crystal molecules of the pixel of the liquid crystal display device of a tenth embodiment. FIG. 35 is a cross-sectional schematic diagram that illustrates a cross section which corresponds to a line segment indicated by the one-dot chain line in FIG. 34.

The tenth embodiment is different from the sixth embodiment in a point that the initial alignment of the liquid crystal molecules is set to 2° in the rightward rotation with respect to the extending direction of the upper layer electrode (i) in the sixth embodiment but is set to 2° in the leftward rotation with respect to the extending direction of the upper layer electrode (i) in the tenth embodiment. The extending direction of each of the lower layer electrode (ii) and the lower layer electrode (iii) is the same as the sixth embodiment, is at 88° with respect to the extending direction of the upper layer electrode (i) in a plan view of the substrate main surface, and as a result forms an angle of 86° to the initial alignment of the liquid crystals.

### Eleventh Embodiment

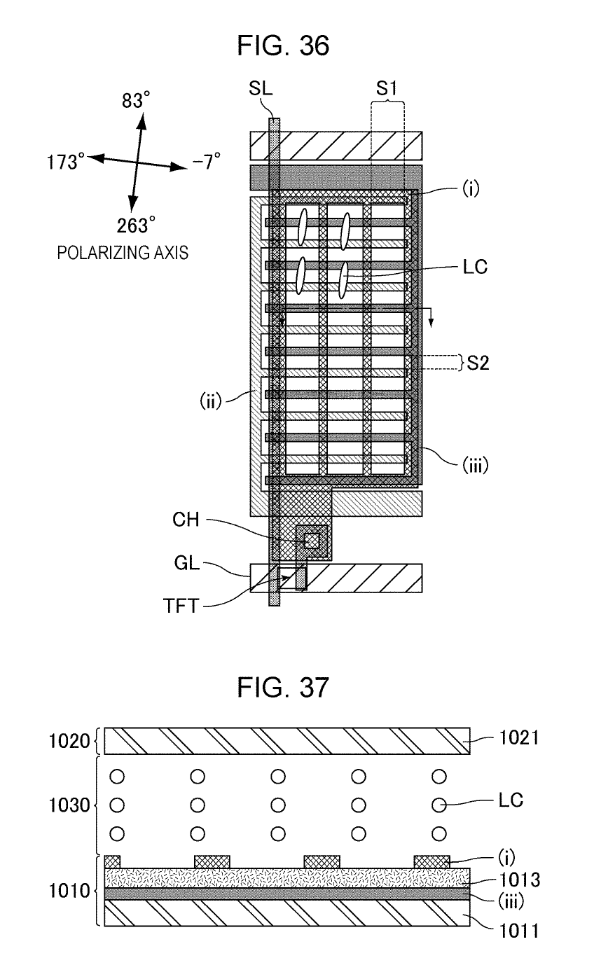

FIG. 36 is a plan schematic diagram that illustrates the electrode structures and the initial alignment of the liquid crystal molecules of the pixel of the liquid crystal display device of an eleventh embodiment. FIG. 37 is a cross-sectional schematic diagram that illustrates a cross section which corresponds to a line segment indicated by the one-dot chain line in FIG. 36.

The eleventh embodiment is different from the first embodiment in a point that the extending direction of each of the lower layer electrode (ii) and the lower layer electrode (iii) is set to 90° with respect to the extending direction of the upper layer electrode (i). Similarly to the first embodiment, the initial alignment of the liquid crystals is set to 7° in the rightward rotation with respect to the extending direction of each of the lower layer electrode (ii) and the lower layer electrode (iii).

### First Comparative Example

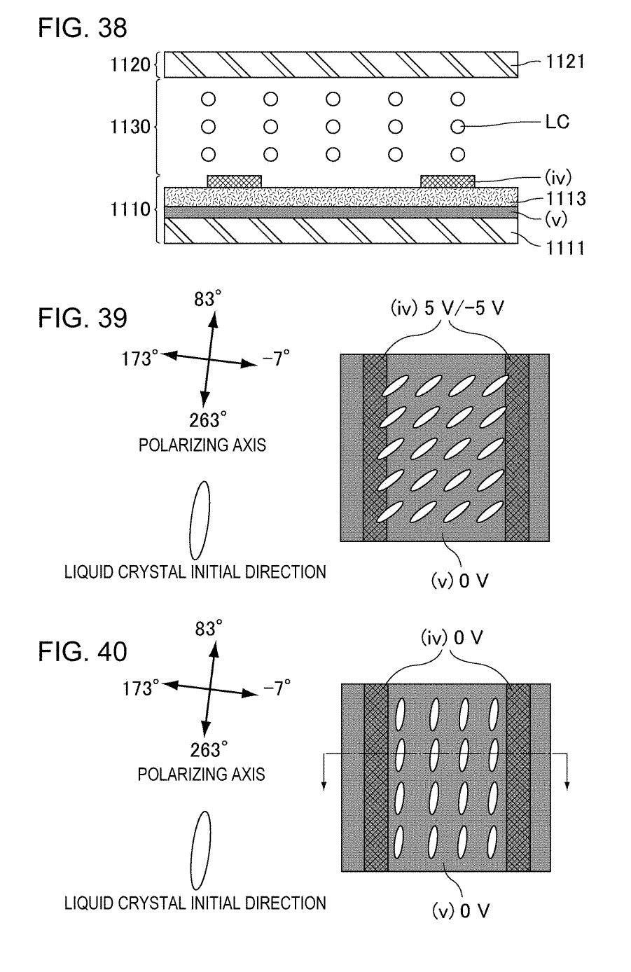

FIG. 38 is a cross-sectional schematic diagram that illustrates electrode structures and initial alignment of the liquid crystal molecules of a liquid crystal display device of the first comparative example. FIG. 38 is also a cross-sectional schematic diagram that illustrates one example of the electrode structures of the liquid crystal display device of the FFS mode in related art.

In the first comparative example, a lower layer electrode (v) of a lower substrate 1110 is the plane electrode, and an upper layer electrode (iv) as the slit electrode is arranged via an insulating layer 1113. Note that the upper layer electrode (iv) may be a pair of comb-shaped electrodes instead of the slit electrode. An electrode for liquid crystal control is not arranged on an upper substrate 1120.

The horizontal alignment film (not illustrated) is provided on each of the liquid crystal layer sides of the upper and lower substrates, and the liquid crystal molecules in a case where no voltage is applied is horizontally aligned such that the direction angle of the liquid crystal molecules is at 7° with respect to a slit extending direction of the upper layer electrode (iv). Further, the polarizers (not illustrated) are respectively provided on the liquid crystal layer side and the opposite side of the upper and lower substrates. The linear polarizers are used as the polarizers, the crossed Nicol arrangement is performed in which the polarizing axis of the polarizers on the upper and lower substrates is vertical or parallel to the major axis of the liquid crystal molecule, and a liquid crystal display device of a normally black mode is provided.

Further, the liquid crystal material and the thickness thereof are the same as the first embodiment. In the upper layer electrode (iv), the electrode width L of the linear portion is 3.0 μm, and the electrode interval S1 between the linear portion and the linear portion that neighbor each other is 6.0 μm. The dielectric constant ε of the insulating layer 1113 is 6.9. Note that as for the liquid crystal display device of the first comparative example, the other configurations such as an alignment film material, an alignment film treatment method, and an insulating film material, for example, are respectively similar to corresponding members of the liquid crystal display device of the above-described first embodiment.

In the first comparative example, the fringe electric field is generated between the upper layer electrode (iv) and the lower layer electrode (v) of the lower substrate, the liquid crystal molecules around a lower electrode are caused to rotate in the same direction in the horizontal plane, and switching in the rise is thereby performed. Further, the switching in the fall is performed by returning the liquid crystal molecules to an original alignment state due to the viscoelasticity by turning off the fringe electric field.

However, a region in which the electric field for causing the liquid crystal molecules to rotate is weak is present in the liquid crystal layer, and a time is requested for rotation of the liquid crystal molecules in the region. Further, in this case, because the liquid crystal molecules rotate in the same direction, strain of the liquid crystals in the horizontal plane due to elastic deformation is low. Thus, in a case where the switching in the fall is performed by turning off the electric field, the response is slow because a restoring force due to elastic strain that works for returning to the original alignment state is small. Accordingly, the response time is slow for both of the switching in the rise and the switching in the fall.

FIG. 39 is a plan schematic diagram that illustrates the applied voltage to each of the electrodes and the alignment of the liquid crystal molecules in the case of white display of the liquid crystal display device of the first comparative example. FIG. 40 is a plan schematic diagram that illustrates the applied voltage to each of the electrodes and the alignment of the liquid crystal molecules in the case of black display of the liquid crystal display device of the first comparative example.

FIG. 39 and FIG. 40 illustrate a principle in voltage application of the first comparative example.

In the initial alignment, the liquid crystal molecules are decided as having the direction that forms an angle of 7° to the extending direction of the upper layer electrode (iv) as the pixel electrode.

A detailed description will first be made about actions of the liquid crystal molecules in the rise (in the case of white display).

In a case where a voltage is applied to the upper layer electrode (iv), the fringe electric field is generated with the upper layer electrode (iv) and the lower layer electrode (v). In this case, the liquid crystals rotate so as to move away from an alignment direction axis, and optical modulation occurs from the black display to the white display. In this comparative example, 5 V is applied to the pixel electrode while the polarity inversion is performed in the case of white gradation display.

A description will next be made about actions of the liquid crystal molecules in the fall (in the case of black display).

The fringe electric field vanishes by turning off the voltage, and the liquid crystal molecules rotate toward the initial alignment direction (anchoring) by the restoring force of the liquid crystal molecules as elastic bodies. The alignment film, an alignment method, and the insulating film that are requested for alignment control of the liquid crystals are similar to those described above in the first embodiment.

### THIRD TO ELEVENTH EMBODIMENTS AND FIRST COMPARATIVE EXAMPLE

Simulations were conducted by using LCD-Master 3D from Shintech, Inc. for confirmation about effects of the third to eleventh embodiments. Results of the conducted simulation for the first comparative example are used in Table 4. The physical property values at an ordinary temperature are used as physical property values of the liquid crystals.

Table 3 represents the transmittances of the first driving scheme and the second driving scheme of the third to eleventh embodiments. It may be understood that in each of the embodiments, the transmittance of the second driving scheme is high compared to the transmittance of the first driving scheme.

Table 4 represents the response times and the transmittances of the third to eleventh embodiments and the first comparative example.

The item of Tr+Td represents the value of Tr+Td given that the response time in which the transmittance changes from 10% to 90% is denoted as Tr and the response time in which the transmittance changes from 90% to 10% is denoted as Td.

The response time/transmittance is calculated as the index for confirming the extent of the compatibility between the high-speed response and high transmittance. As this value is smaller, the compatibility between the high-speed response and the high transmittance is higher.

As illustrated in Table 4, because the response time/transmittance of the third to eleventh embodiments are smaller values than the first comparative example, it may be considered that the third to eleventh embodiments as the driving in which the compatibility between the high-speed response and the high transmittance may be realized are superior to the first comparative example.

In consideration of the first embodiment and the third embodiment together, it may be considered that a comb interval S2 between the lower layer electrode (ii) and the lower layer electrode (iii) in the present invention is particularly desirably 3 μm or more and 6 μm or less.

In consideration of the first embodiment and the fourth to eleventh embodiments together, it may be considered that as for the initial alignment direction of the liquid crystal molecules in the present invention, the angle formed with the extending direction of the upper layer electrode (i) is desirably −7° or larger and 7° or smaller.

In addition, each of the angle formed between the extending direction of the upper layer electrode (i) and the extending direction of the lower layer electrode (ii) and the angle formed between the extending direction of the upper layer electrode (i) and the extending direction of the lower layer electrode (iii) is preferably 83° to 90°. Further, it is preferable that the extending direction of the lower layer electrode (ii) is substantially parallel to the extending direction of the lower layer electrode (iii).

TABLE 3

| | Transmittance (%) | |
|---|---|---|
| | First driving scheme | Second driving scheme |
| Third embodiment | 9.2 | 28.6 |
| Fourth embodiment | 12.4 | 34.6 |
| Fifth embodiment | 12.4 | 34.9 |
| Sixth embodiment | 12.3 | 35.1 |
| Seventh embodiment | 12.0 | 34.1 |
| Eighth embodiment | 12.3 | 34.5 |
| Ninth embodiment | 12.5 | 34.8 |
| Tenth embodiment | 12.4 | 35.0 |
| Eleventh embodiment | 11.9 | 34.2 |

TABLE 4

| | | | Tr + Td |
|---|---|---|---|
| | Tr + Td | Transmittance | (ms)/Transmittance |
| | (ms)*¹ | (%)*² | (%) |
| Third embodiment | 22.1 | 28.6 | 0.772 |
| Fourth embodiment | 24.3 | 34.6 | 0.702 |
| Fifth embodiment | 20.6 | 34.9 | 0.590 |
| Sixth embodiment | 18.8 | 35.1 | 0.536 |
| Seventh embodiment | 17.9 | 34.1 | 0.526 |
| Eighth embodiment | 18.9 | 34.5 | 0.548 |
| Ninth embodiment | 18 | 34.8 | 0.517 |
| Tenth embodiment | 17.6 | 35.0 | 0.503 |
| Eleventh embodiment | 20.3 | 34.2 | 0.594 |
| First comparative | 29.8 | 34.6 | 0.861 |
| example | | | |

*¹The response times of the third to eleventh embodiments are values in the first driving scheme.
*²The transmittances of the third to eleventh embodiments are values in the second driving scheme.

As for the liquid crystal display device of the above-described embodiments, in the first driving scheme, in the rise, the lateral electric field is applied to the pair of comb-shaped electrodes in the lower layer, a strong electric field thereby works for the liquid crystal molecules in the whole range in the horizontal plane, and the response is thus performed at a high speed. In the fall, a strong restoring force works, the strong restoring force attempting to return to the original state from in-plane bend and the splay alignment illustrated in FIG. 3, and further the liquid crystal molecules react to the electric field produced by the comb-shaped electrodes in the lower layer. Accordingly, the high-speed response that may not be realized by the FFS mode in related art may be realized.

Further, in the second driving scheme, the comb-shaped electrodes on the lower side of the two layers of the electrodes are set to the same electric potentials, and the fringe electric field may thereby be generated between the comb-shaped electrodes and the slit electrode on the upper side. Accordingly, the second driving scheme becomes the driving that realizes the high transmittance compared to the driving that is driven as described above and realizes the high-speed response.

Those two kinds of driving may be switched in accordance with a purpose or a situation, and as a result the wide viewing angle, the high-speed response, and the high transmittance may be realized. Those are some characteristics of the above-described embodiments. Note that the liquid crystal display device of the present invention may be a liquid crystal display device that may execute at least the first driving scheme.

The liquid crystal display device of the above-described embodiments may perform display while appropriately switching the first driving scheme and the second driving scheme. Further, in each of the driving schemes, display may be performed while the white display and the black display are appropriately combined in accordance with desired display.

The liquid crystal display device of the present invention preferably includes a control device that executes the above-described first driving scheme and further preferably includes a control device that executes the above-described first driving scheme and second driving scheme while switching those. Accordingly, the wide viewing angle may be realized, the high-speed response may be realized, and the high transmittance may be realized. Therefore, one kind of an electrode configuration may realize a liquid crystal display device that achieves all the characteristics of the high-speed response, the wide viewing angle, and the high transmittance.

Further, the liquid crystal display device of the present invention preferably includes a control device that automatically switches the above-described first driving scheme and second driving scheme in accordance with a prescribed condition. The control device preferably has a temperature sensor installed therein, for example, and automatically switches the first driving scheme and the second driving scheme in accordance with the temperature. For example, the control device is preferably a control device that performs control such that the second driving scheme is executed which may realize the high transmittance under a temperature environment (for example, a temperature range in which a lower limit is any of −20° C. to 20° C.) in which a response speed delay is not a problem and the first driving scheme is executed which may realize the high-speed response under an low-temperature environment (for example, a temperature range in which an upper limit is any of −20° C. to 20° C.) in which the response speed becomes slow. Accordingly, a desired effect may be obtained more properly.

Further, the liquid crystal display device of the present invention preferably includes a control device that switches the above-described first driving scheme and second driving scheme in accordance with an instruction by a user.

Further, the present invention may be a driving method of a liquid crystal display device by using the above-described liquid crystal display device.

In a case where alternating current driving of the liquid crystals may be performed in which alternating-current voltages are applied to only the electrodes of the lower substrate as the liquid crystal display device of the present invention, circuits, drivers, and wiring for the alternating current driving may be arranged only for the electrodes of the lower substrate as in related art. Accordingly, for example, compared to the liquid crystal display device in which the circuits, drivers, and wiring for the alternating current driving are arranged for the lower substrate and the upper substrate in order to perform the alternating current driving of the liquid crystals by applying the alternating-current voltages to the electrodes of the lower substrate and the electrodes of the upper substrate, the degree of freedom of the driving of the liquid crystal display device of the present invention is considerably high.

Examples of the liquid crystal display device of the present invention include in-vehicle equipment such as a car navigation system, an electronic book, a photo frame, industrial equipment, a television, a personal computer, a smartphone, a tablet terminal, and so forth. The present invention is preferably employed for equipment that may be used under both of a high-temperature environment and a low-temperature environment such as in-vehicle equipment such as a car navigation system, for example.

Note that in the lower substrate, the electrode structures and so forth related to the liquid crystal display device of the present invention may be checked by microscopy by a scanning electron microscope (SEM) or the like.

### REFERENCE SIGNS LIST

(i) upper layer electrode

(ii) lower layer electrode

(iii) lower layer electrode

(iv) upper layer electrode

(v) lower layer electrode

CH contact hole

TFT thin-film transistor element

SL source bus line

GL gate bus line

LC liquid crystal molecule

10, 210, 310, 410, 510, 610, 710, 810, 910, 1010, 1110 lower substrate

11, 21, 211, 221, 311, 321, 411, 421, 511, 521, 611, 621, 711, 721, 811, 821, 911, 921, 1011, 1021, 1111, 1121 glass substrate

13, 213, 313, 413, 513, 613, 713, 813, 913, 1013, 1113 insulating layer

20, 220, 320, 420, 520, 620, 720, 820, 920, 1020, 1120 upper substrate

30, 230, 330, 430, 530, 630, 730, 830, 930, 1030, 1130 liquid crystal layer

1. A liquid crystal display device that has upper and lower substrates and a liquid crystal layer which is interposed between the upper and lower substrates,
wherein
the lower substrate includes electrodes,
the electrodes are configured with a first electrode, a second electrode in a different layer from the first electrode, and a third electrode in a same layer as the second electrode,
the liquid crystal layer includes liquid crystal molecules that are horizontally aligned with respect to a main surface of the upper and lower substrates in a case where a voltage is not applied, and
the liquid crystal display device is configured to execute a driving operation that causes the electrodes to generate an electric field which causes a portion of the liquid crystal molecules to rotate in a horizontal plane with respect to the main surface and causes another portion of the liquid crystal molecules to rotate in an opposite direction to the portion of the liquid crystal molecules in the horizontal plane with respect to the main surface.

2. The liquid crystal display device according to claim 1, wherein
the liquid crystal display device is configured to execute a driving operation that causes the electrodes to generate an electric field which causes the liquid crystal molecules to rotate such that two or more first regions, the first region in which a portion of the liquid crystal molecules is aligned in one direction, and two or more second regions, the second region in which another portion of the liquid crystal molecules is aligned in a different direction from the portion of the liquid crystal molecules, are alternately arranged in a picture in a plan view of the main surface of the upper and lower substrates.

3. The liquid crystal display device according to claim 1,
wherein
slits are provided in at least one of the first electrode, the second electrode, and the third electrode, and
the liquid crystal display device is configured to execute a driving operation that causes the electrodes to generate an electric field which causes a portion of the liquid crystal molecules to rotate in the horizontal plane with respect to the main surface and causes another portion of the liquid crystal molecules to rotate in an opposite direction to the portion of the liquid crystal molecules in the horizontal plane with respect to the main surface in a region which overlaps with the slits in a plan view of the main surface of the upper and lower substrates.

4. The liquid crystal display device according to any claim 1, wherein
the liquid crystal display device is configured to execute a first driving scheme that executes the driving operation and to execute a second driving scheme that executes a driving operation which causes the electrodes to generate an electric field which causes the liquid crystal molecules to rotate in one direction in the horizontal plane with respect to the main surface of the upper and lower substrates while the first driving scheme and the second driving scheme are switched.

5. The liquid crystal display device according to claim 1, wherein
the first electrode is arranged closer to a side of the liquid crystal layer than the second electrode and the third electrode.

6. The liquid crystal display device according to claim 1, wherein
each of the second electrode and the third electrode is in a comb shape.

7. The liquid crystal display device according to claim 6, wherein
in a plan view of the main surface of the upper and lower substrates, an extending direction of the second electrode and an extending direction of the third electrode intersect with an alignment direction of the liquid crystal molecules in a case where a voltage is not applied.

8. The liquid crystal display device according to claim 6, wherein
a comb interval of the second electrode and the third electrode is 3 μm or more and 6 μm or less.

9. The liquid crystal display device according to claim 1, wherein
the first electrode is provided with slits or is in a comb shape.

10. The liquid crystal display device according to claim 9, wherein
in a plan view of the main surface of the upper and lower substrates, an angle that is formed between an extending direction of the first electrode and the alignment direction of the liquid crystal molecules in a case where a voltage is not applied is -7° or larger and 7° or smaller.

11. The liquid crystal display device according to claim 9, wherein
in a plan view of the main surface of the upper and lower substrates, an angle that is formed between the extending direction of the first electrode and the extending direction of the second electrode and the extending direction of the third electrode is 83° to 90°.

12. The liquid crystal display device according to claim 1, wherein
the liquid crystal molecule has positive dielectric anisotropy.

13. The liquid crystal display device according to claim 1, wherein
the lower substrate includes a thin-film transistor element, and
the thin-film transistor element includes oxide semiconductor.
